(19) United States
(12) Patent Application Publication
(10) Pub. No.: US 2003/0191043 A1
(43) Pub. Date: Oct. 9, 2003

(54) Methods and formulations for enhancing the dissolution of a solid material in liquid

(76) Inventors: Nathaniel T. Becker, Hillsborough, CA (US); Scott William Capeci, North Bend, OH (US); Edward M. Concar, San Francisco, CA (US); Giselle Janssen, San Carlos, CA (US); Alisha Jarnagin, San Mateo, CA (US); Genevieve Cagalawan Kipte, Fort Mitchell, KY (US); Eric Lippay, San Carlos, CA (US); Edgar Manuel Marin-Carillo, West Chester, OH (US); Ayrookaran J. Poulose, Belmont, CA (US); Michael Stanford Showell, Cincinnati, OH (US); Landon Steele, Brisbane, CA (US); Suzanne Stoner, Belmont, CA (US); Doreen C. Victoria, San Francisco, CA (US)

Correspondence Address: T. Gene Dillahunty, BURNS, DOANE, SWECKER & MATTIS, L.L.P., P.O. Box 1404, Alexandria, VA, 22313-1404, US

(21) Appl. No.: 10/159,950

(22) Filed: May 31, 2002

Related U.S. Application Data
(60) Provisional application No. 60/295,248, filed on Jun. 1, 2001.
(60) Provisional application No. 60/343,665, filed on Dec. 26, 2001.

(51) Int. Cl. C11D 3/386

(52) U.S. Cl. 510/392; 510/530

(57) ABSTRACT

Methods and formulations for enhancing the dissolution of a solid material in an aqueous solution incorporate an effervescent system into the material. Effervescent systems include (i) the combination of one or more enzymes and one or more substrates for said enzymes and (ii) a metal ion catalyst and a substrate for that metal ion catalyst. The combination of either (i) the enzyme and the substrate or (i) metal ion catalyst and substrate is capable of producing a gas when the material is in an aqueous solution. The effervescent system is particularly suited for incorporation into laundry detergents, dishwashing detergents, antacids, vitamins, contact lens cleaners, denture cleaners and other household products. It is believed that the gas produced by the interaction of the enzyme or metal ion catalyst and the appropriate substrate enhances and facilitates dissolution of the material by increasing the surface area of the material that is in contact with the aqueous medium.

### REFERENCE TO RELATED APPLICATIONS

This application claims priority to U.S. Provisional Applications S/N 60,295,248 filed Jun. 1, 2001 and 60/343,665 filed Dec. 26, 2001, both of which are incorporated herein by reference in their entireties.

### FIELD OF THE INVENTION

This invention is directed to techniques for enhancing the dissolution of an active-containing material in a liquid and in particular to effervescent systems that are incorporated into the material, and/or techniques for generating a consumer recognizable signal from an effervescent system. The effervescent system may produce a gas. The gas may facilitate dissolution of a material when it is placed in a liquid environment and/or may generate a consumer recognizable signal, such as by communicating a signal to a consumer using the effervescent system that the effervescent system is working for its intended purpose.

### BACKGROUND OF THE INVENTION

Many consumer products are manufactured and sold in solid form for use in a liquid environment. These products include, for example, laundry detergents, dishwashing detergents, antacids, vitamins, contact lens cleaners, and denture cleaners. Often, these products exhibit sub-optimal dissolution rates when they are placed in the liquid environment. As a result, the active ingredients do not become rapidly available as desired and/or the consumer is required to agitate the liquid to dissolve the product. Sub-optimal dissolution is often characterized by the presence of residue in the liquid. The art is in search of techniques for enhancing the dissolution rates of solid products in liquids and for providing a consumer signal to indicate that such dissolution has occurred.

### SUMMARY OF THE INVENTION

The invention is based in part on the discovery that the dissolution of a material can be enhanced by incorporating an effervescent system that is capable of producing a gas upon contact with a liquid, e.g., aqueous medium and/or that an effervescent system can be used to provide a consumer recognizable signal. Without being limited to any theory, it is believed that the gas produced increases the material's overall surface area that is in contact with the liquid and thus increases dissolution.

Accordingly, one aspect of the invention is directed to a method for enhancing the dissolution of a material in an aqueous solution which method includes:

(a) selecting a material to be dissolved in an aqueous solution;

(b) incorporating into said material one or more first enzymes and one or more substrates for said one or more first enzymes wherein the combination of said one or more first enzymes and said one or more substrates is capable of producing a gas in the aqueous solution, which gas facilitates dissolution of the material therein; and

(c) optionally, incorporating into said material a modulating agent which modulates the activities of the one or more first enzymes.

In another aspect, the invention is directed to a method for enhancing the dissolution of a material in an aqueous solution which method includes:

(a) selecting a material to be dissolved in an aqueous solution;

(b) incorporating into said material one or more first enzymes and one or more substrates for said one or more first enzymes wherein the combination of said one or more first enzymes and said one or more substrates is capable of producing a gas in the aqueous solution;

(c) optionally, incorporating into said material modulating agents which modulate the activities of the one or more first enzymes; and

(d) placing said material, produced by steps (b) and (c), into said aqueous solution while maintaining said aqueous solution under conditions wherein a gas is generated by the combination of said one or more first enzymes and said one or more substrates which gas facilitates the dissolution of said material.

In a further aspect, the invention is directed to a detergent composition that includes:

(a) one or more surfactants;

(b) one or more first enzymes;

(c) optionally, modulating agents which modulate the activities of the one or more first enzymes, and

(d) one or more substrates for said one or more first enzymes;

wherein the combination of said one or more first enzymes and said one or more substrates is capable of producing a gas in an aqueous solution.

In yet another aspect, the invention is directed to a detergent composition comprising one or more surfactants and an enzyme substrate, having admixed thereto one or more granules that includes:

(a) a first enzyme;

(b) optionally, modulating agents which modulate the activities of the first enzymes; and

(c) a reaction barrier layer that prevents the first enzyme from reacting with the enzyme substrate before the detergent composition is placed in the aqueous solution; and wherein the combination of the first enzyme and the substrate is capable of producing a gas in an aqueous solution.

In another further aspect, the invention is directed to a detergent composition comprising one or more surfactants and an enzyme substrate, having admixed thereto one or more granules, wherein said granules includes:

(a) a surfactant;

(b) a first enzyme; and

(c) optionally, modulating agent which modulate the activities of the first enzymes; and

(d) barrier layer which dissolves in aqueous solution exposing said first enzyme to said enzyme substrate and wherein the combination of the first enzyme and said enzyme substrate is capable of producing a gas in aqueous solution.

In yet another aspect, the invention is directed to a detergent composition comprising one or more surfactants having admixed thereto one or more granules, wherein said granules includes:

(a) a core comprising an enzyme substrate;

(b) a first barrier layer surrounding said core;

(c) an enzyme layer containing an enzyme that is compatible with the enzyme substrate such that the combination of said enzyme and said enzyme substrate is capable of producing a gas in aqueous solution; and

(d) optionally, a second barrier layer surrounding said enzyme layer, wherein said second layer comprises a moisture barrier material.

In a further aspect, the invention is directed to a detergent composition comprising one or more surfactants having admixed thereto one or more granules, wherein said granules includes:

(a) a core;

(b) a first enzyme layer, surrounding said core, which contains an enzyme that is compatible with an enzyme substrate such that the combination of said enzyme and said enzyme substrate is capable of producing a gas in an aqueous solution;

(c) a second barrier layer surrounding said first enzyme layer;

(d) a third enzyme substrate layer comprising an enzyme substrate; and

(e) optionally, a protective coating surrounding said third enzyme substrate layer.

In still another aspect, the invention is directed to an effervescent composition comprising an effervescent system comprising an enzyme and a substrate, wherein said effervescent composition generates a consumer recognizable signal upon contacting an environment from which generation of a consumer recognizable signal is desired.

In even still another aspect, the invention is directed to an effervescent system and/or composition wherein a first component and a second component are in close physical proximity to one another such that when the first component and second component interact, chemically and/or physically, as a result of contacting an environment, such as a liquid environment, a consumer recognizable signal is generated. “Close physical proximity” as used herein can mean that the first component and the second component are within 5000 microns and/or 3000 microns and/or 2000 microns and/or 1000 microns and/or from about 1 to about 5000 microns and/or from about 10 to about 3000 and/or from about 10 to about 2000 and/or from about 50 to about 1500 microns of each other.

### BRIEF DESCRIPTION OF THE DRAWINGS

FIGS. 1 to 9 illustrate various embodiments of solid compositions containing effervescent systems.

### DETAILED DESCRIPTION OF THE INVENTION

This invention is directed to methods and formulations for enhancing the dissolution of a material in a liquid system and particularly in aqueous environments. Preferred techniques of this invention incorporate an effervescent system into the material. The effervescent system can be formulated into any suitable material and/or the effervescent system itself can be the material. Preferred materials include non-liquid household consumer products.

Effervescent systems and/or compositions of the present invention are formulated from at least two components that provide a consumer recognizable signal and/or may generate a gas when they are combined in a liquid environment. The effervescent systems and/or compositions of the present invention may be in the form of a single particle and/or in a granule, co-granule, tablet, agglomerate, and/or mixtures thereof. In the single particle and/or co-granule form, the two components of the effervescent system are present on a single particle. In the tablet and/or agglomerate form, the two components may be on separate, discrete particles. This is the case even in the form of tablets and/or agglomerates wherein the tablets and/or agglomerates are physically made of compressed and/or agglomerated separate, discrete particles. In one embodiment, the effervescent system and/or composition comprises a first component and a second component such that when the first component and second component interact, chemically and/or physically, as a result of contacting an environment, such as a liquid environment, a consumer recognizable signal is generated.

In another embodiment, the effervescent system and/or composition comprises (i) one or more enzymes and (ii) one or more substrates for said enzymes such that the efferevescent system and/or composition generates a consumer recognizable signal upon contacting an environment from which generation of a consumer recognizable signal is desired.

In yet another embodiment, the effervescent system and/or composition can be incorporated into a material to be dissolved. The combination of the enzymes and the substrates is capable of producing a gas when the material is placed in an aqueous solution. The gas produced by the interaction of the enzymes and the substrates enhances and facilitates dissolution of the material in the aqueous solution.

In another embodiment, the effervescent system comprises (i) one or more metal ion catalysts and (ii) one or more appropriate substrates for said metal ion catalysts. The combination of the metal ion catalysts and substrates is also capable of producing a gas when a material, containing the same, is placed in an aqueous solution.

In even yet another embodiment, a method of producing an effervescent system and/or composition comprising the steps of identifying a first component, such as an enzyme, and second component, such as a substrate, to form an effervescent system and/or composition adapted for generation of a consumer-recognizable signal.

In still another embodiment, a method of generating a consumer recognizable signal comprising placing an effervescent system and/or composition according to the present invention into an environment from which generation of a consumer-recognizable signal is desired.

However, prior to discussing this invention in further detail, the following terms will be defined:

The term “material” refers to any non-liquid substance that is soluble in a liquid, e.g., water. The material can be in the form of a solid, paste, foam or gel. Preferably, the material is a solid that is configured as a tablet, bar, powder, granule, or crystal. The material may contain minor amounts of water which can be present as hydrates of the solid material. Alternatively, when the amount of water is higher, the material may have the consistency of a paste, concentrate or gel. Suitable materials for the present invention include, for example, laundry detergents, dishwashing detergents, hard surface cleaners, toilet bowl cleaners, health care products such as antacids and vitamins, contact lens cleaners, and oral hygiene and denture cleaners.

The term “aqueous solution” is a solution comprising water and one or more optional additives such as buffers, bleaching agents, perfumes, softening agents, swelling agents, disintegrating agents (e.g., cross-linked acrylates), colorants, stabilizers, and salts.

The term “gas” refers to any vapor phase component produced by the effervescent system in the aqueous solution. Such gases include, for example, oxygen (O₂), carbon dioxide (CO₂), and nitrogen (N₂).

The term “enzyme” refers to a catalytic protein which, when combined with the appropriate substrate, is capable of producing a gas when the combination of the enzyme and substrate is placed in a liquid such as an aqueous solution. The production of gas enhances the dissolution of a material into which the enzyme and substrate have been incorporated.

The term “substrate” refers to a substance upon which an enzyme acts catalytically and which, when combined with the appropriate enzyme, is capable of producing a gas in a liquid.

Examples of suitable oxygen generating enzyme and substrate combinations include, for example, glucose oxidase and glucose catalase (and hydrogen peroxide), and catalase and perborate or percarbonate. Examples of suitable carbon dioxide generating enzyme and substrate combinations include, for example, carbonic anhydrase and bicarbonate, and amino acid decarboxylase and amino acid, pyruvate decarboxylase and pyruvate. Other examples of suitable enzyme/substrate pairs include, for example, alcohol dehydrogenase and alcohol, acyl transferase and an acyl moiety. These enzyme/substrate pairs may generate gas in the form of volatile compounds. Another example of an enzyme/substrate pair is isocitrate dehydrogenase and a citrate or isocitrate.

Additional enzymes and/or cofactors may be needed to facilitate the enzymatic processes. For example, additional enzymes (aconitase) and/or cofactors (NAD) may be needed to facilitate the production of CO₂ from either citrate or isocitrate. The use of such enzymes and cofactors are well known to those skilled in art.

The term “metal ion catalyst” refers to a metal ion catalyst which, when combined with the appropriate substrate, is capable of producing a gas in an aqueous solution. The production of this gas can be used to enhance the dissolution rate of a material when the metal ion catalyst and the substrate have been incorporated into the material. The metal ion catalyst can be free, complexed, coordinated, or in a salt.

Examples of metal ion catalysts suitable for use in the invention include, for example, iron (Fe²⁺, Fe³⁺), zinc (Zn²⁺), manganese (Mn²⁺), and selenium (Se³⁺).

Examples of suitable metal ion catalyst/substrate pairs include, for example, iron and percarbonate and/or perborate, zinc and diethyloxaloacetate, manganese and diethyloxaloacetate, and manganese and carboxylic acid.

In one embodiment of this invention, both a metal ion catalyst and a modulating agent are incorporated in a material along with the substrate. The combination of the metal ion catalyst with the substrate is capable of producing a gas in an aqueous solution whereas the modulating agent is capable of modulating the activity of metal ion catalyst. The modulating agent is used to reduce any undesirable side effects caused by the use of the combination of the metal ion catalyst and substrate. Examples of suitable modulating agents include, for example, chelants, inhibitors and enzyme denaturants. It should be noted that the activity of the metal in catalyst (and enzyme) can also be modulated by controlling the pH and/or temperature of the aqueous medium into which the material is placed.

The term “reaction barrier” refers to any means for preventing or inhibiting contact between gas producing components of the effervescent system. The reaction barrier is typically an intermediate layer in a multi-layer material or composition. For example, a reaction barrier can separate the enzymes and the enzyme substrates prior to dissolution of the material in liquid. The reaction barrier may be a physical barrier that dissolves in liquid. For example, the reaction barrier can be made of a water soluble polymeric material and/or materials. Preferred water soluble materials include, for example, polyvinylacetate, methyl cellulose waxes and the like, sodium chloride, sucrose, magnesium sulfate, ammonium sulfate, hydroxypropyl methyl cellulose, ethyl cellulose, carboxy methyl cellulose, acacia gum, polyvinylpyrrolidone, mono and diglycerides, polyethylene glycol, non-ionic surfactants, starch, hydroxypropyl starch, hydroxyethyl starch and other modified starches.

In another embodiment, the reaction barrier expands in liquid to create pores. For example, the reaction barrier can be made of a water swellable polymer that on contact with an aqueous solution will swell sufficiently to release the enzyme to react with the substrate.

When a material that is coated with a reaction barrier is placed in an aqueous solution, the reaction barrier will typically dissolve or fully expand to create pores in less than 10 minutes and preferably between 0 to 60 seconds, and most preferably in less than 15 seconds.

The term “disrupt” refers to processes that alter the ability of the reaction barrier to physically separate the gas producing components of the effervescent system, e.g., enzymes and enzyme substrates. One technique is to dissolve the reaction barrier in an aqueous solution. Another technique is to expand or swell the reaction barrier in an aqueous solution.

The term “protective coat” refers to an outer film or layer that is applied onto a powder, granule or other form of a material or composition of the present invention. The protective coat can serve any of a number of functions. For example, the protective coat may be applied to an enzyme layer as an exterior barrier against ambient moisture in order to enhance the storage stability of the enzyme. The protective coat typically contains water-soluble fillers, such as, for example, alkali chloride, alkali acetate, alkali sulfate, calcium carbonate, calcium sulfate, magnesium sulfate, sugar such as e.g., sucrose, lactose, maltose and other disaccharides, trisaccharides or polysaccharides such as dextrins. Alternatively, the protective coat is a water-resistant barrier that is wrapped or coated over the material or composition.

The term “acid neutralizing agent” refers to an acid neutralizing agent that is in solid form. Suitable acid neutralizing agents include, for example, sodium bicarbonate, sodium carbonate, potassium bicarbonate, and calcium carbonate.

The term “modulating agent” refers to any agent which enhances or neutralizes (reduces) the activity of the enzyme and its respective substrate.

The term “compatible” with respect to an enzyme-substrate pair, means that the pair, when combined in a liquid, e.g., aqueous solution, is capable of producing gas.

The term “granule” refers to a water soluble or dispersible particle preferably having a mean diameter of from about 50 to 2,000 microns.

The term “co-granule” refers to a water soluble or dispersible single particle having at least two components that generate a gas when they are combined in a liquid environment. The two components may be one or more enzymes and one or more substrates for said enzymes, or one or more metal ion catalysts and one or more appropriate substrates for said metal ion catalysts. The co-granule is a preferred particle because by combining the two components in a single particle, they are held in close physical proximity, separated by at most a reaction barrier, during the period of disruption or dissolution into aqueous solution. By means of such physical proximity, the localized concentrations of reactants are maximized and the rate of reaction and gas generation is maximized.

The term “powder” refers to a particulate solid having a mean diameter of less than about 50 microns.

The term “tablet” refers to a compressed solid formulation typically weighing between about 1 and 100 grams. There are a variety of compaction processes to prepare tablets including, for example, tableting, briquetting and extrusion. After compression, the tablet should have a hardness of between about 10 to 300 N as measured by a Dr. Schleuniger Pharmatron 6D hardness tester and preferably having a breaking strength of less than about 150 N.

The term “bar” refers to a compressed solid formulation typically having a volume of at least about 100 cm³ and preferably from about 240 to about 920 cm³. Bars can have any configuration such as cubes and discs. Preferably, each bar weighs between about 30 and 400 grams.

The term “consumer recognizable signal” refers to any sensory receivable condition that a consumer can recognize. Nonlimiting examples include visual signals, audible signals, olfactory signals, touch/feel signals and mixtures thereof. Nonlimiting examples include color changes, bubble formation, foam formation, suds formation, crackling sound, fizzing sound, perfume smell, viscosity change, temperature change and mixtures thereof. The consumer recognizable signal may be generated at any time after adding the effervescent system and/or composition to the environment. In one embodiment, the consumer recognizable signal may be generated during a reasonable amount of time after the consumer adds the effervescent system and/or composition to the environment. In another embodiment, the consumer recognizable signal may be generated from about 0 to about 5 minutes and/or from about 1 second to about 3 minutes and/or from about 1 second to about 2 minutes and/or from about 1 second to about 15 seconds after the effervescent composition is contacted with said environment.

Preparation of Solid Compositions Containing Effervescent Systems

Compositions comprising materials, effervescent systems, modulating agents and other components can be prepared by conventional means. Formulation of the compositions of the invention will be illustrated using the enzyme/enzyme substrate pairs as the effervescent system however it is understood that the techniques described herein are also applicable to other effervescent systems. As is apparent, the various components can be arranged in a myriad of combinations some of which will further described herein.

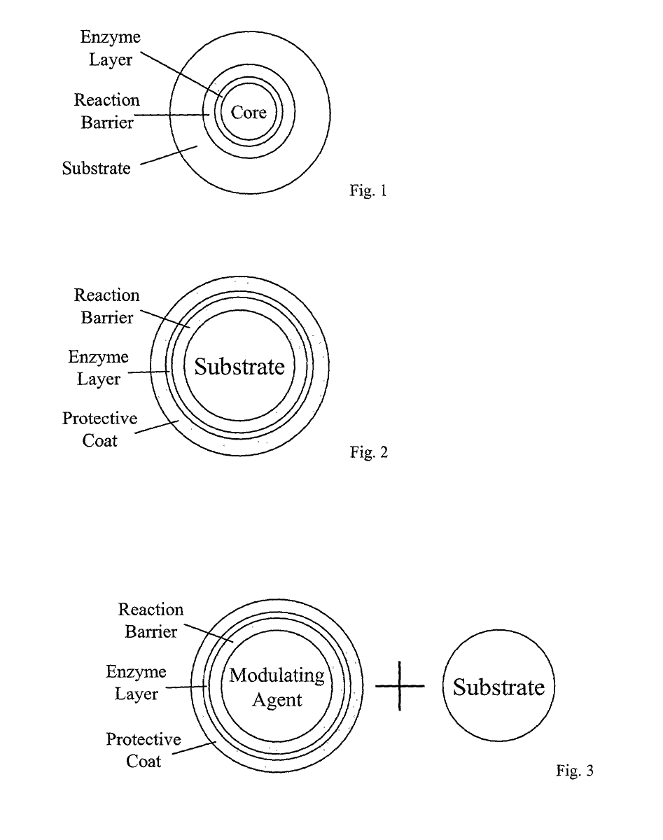

FIGS. 1 to 9 illustrate various preferred embodiments of the compositions containing the effervescent system. As is apparent, the compositions may comprise two granules, co-granules, and agglomerates of granules and/or co-granules. The granule composition of FIG. 1 includes an inert (e.g., sucrose) core onto which are applied a first enzymatic layer, a second reaction barrier, and a third enzymatic substrate layer. Syntheses of the other embodiments shown in FIGS. 2-9 are described herein in Examples 10-17.

Compositions of the present invention are typically formulated into a powder, tablet, bar, or granule. When the composition is in the form of a powder, the enzyme and substrate are preferably distributed evenly throughout the material. The powder is typically mixed to avoid segregation of components and ought to be kept in a cool, dry place prior to use to avoid inactivation and reaction between components. The powder should be protected from extreme mechanical forces such as harsh agitation.

When the composition is in the form of a granule, the granule typically comprises a core and one or more layers. The core may comprise detergent, cornstarch, sugar, clays, nonpareils, agglomerated potato starch, fillers, plasticizers, fibrous material, particles composed of inorganic salts and/or sugars and/or small organic molecules, zeolites, peroxide sources, including but not limited to bleaching agents, or protein(s). The core may also comprise substrate, e.g., sodium perborate or sodium carbonate. Nonpareils are spherical particles consisting of a seed crystal that has been built onto and rounded into a spherical shape by binding layers of powder and solute to the seed crystal in a rotating spherical container. Nonpareils are typically made from a combination of a sugar such as sucrose and a powder such as corn starch. Alternate seed crystal materials include sodium chloride or sulfate seeds and other inorganic salts which may be built up with ammonium sulfate, sodium sulfate, and potassium sulfate. See, for example, U.S. Pat. No. 5,324,649 which is incorporated herein by reference.

Cores can be made in a variety of ways including crystallization, precipitation, pan-coating, fluid-bed coating, rotary atomization, extrusion, spheronization and high-shear glomeration.

Layers of material can be coated over the core using conventional devices, for instance, a Vector FL-1 fluid bed coater and fluidizer. The layers that cover the core of the granule can comprise one or more of the following: enzyme, reaction barrier material, substrate, modulating agent, and surfactants, as well as plasticizers, pigments, lubricants such as surfactants or anti-static agents.

The granules can be further compacted into tablets. The tablet can be prepared by, for instance, adding the granules and, optionally other substances, e.g., detergent, into a Stokes Model R4 single station tablet press. The mixture could then be compressed to a hardness of between 10-300 N as measured by a Dr. Schleuniger Pharmatron, Inc. 6D tablet hardness tester. Conventional methods of making tablets from a detergent mixture can be employed.

A reaction barrier can be incorporated into the materials to ensure that the enzymes and substrates are unreactive until the material, with the enzymes and substrates incorporated therein, is placed in an aqueous solution. Typically, a reaction barrier consists of an intermediate coating that physically separate the enzymes and substrates.

A modulating agent can also be incorporated into the material. This modulating agent can enhance or neutralize (reduce) the activity of the enzyme and its substrate. Modulating agents that neutralize the activity of the enzyme and its substrate include, for example, proteolytic or competing enzymes, metal or substrate chelators, competing metal analogs, enzyme inhibitors, and denaturants e.g., salts and detergents.

Modulating agents that enhance the activity of the enzyme and its substrate may include, for example, activators, such as co-factors, metals and a coupled enzyme system, in which one enzyme upon catalysis furnishes, as a by-product, the substrate for the second enzyme. Another technique employs heat as the modulating agent to increase gas pressure. For instance, a chemical agent/reaction that causes an exothermic reaction would enhance the release of bubbles through gas expansion. For example, pellets of sodium hydroxide when mixed with water generate heat upon dissolving. Similarly, small pellets of sodium metal or potassium metal or magnesium metal generate significant heat upon mixing and reacting with water. These materials could be sequestered through formulation to control the timing and direct the force of the exothermic reaction.

An example of an exothermic enzymatic reaction is the conversion of the substrate hydroquinone through a coupled set of reactions with the enzymes peroxidase and catalase to quinone, water and heat. The various components could also be formulated to control the timing and direct the force of the enzymatic reactions.

The modulating agent can also be an enzyme. Accordingly, in embodiments that employ the enzyme/substrate combination with a modulating agent, at least two enzymes may be incorporated into the material. The first enzyme produces gas when in combination with the substrate, while the second enzyme modulates the activity of the first enzyme. The second enzyme can be used to reduce any undesirable side effects caused by the use of the combination of the first enzyme and substrate. For example, when the first enzyme is catalase, this first enzyme can deactivate the hydrogen peroxide needed for bleaching in the bulk detergent. To decrease or minimize this effect, a second enzyme such as a protease is incorporated into the material to neutralize the activity of the catalase after it has generated gas bubbles.

The modulating agent can also be segregated to a part of the detergent or granule away from the first enzyme, in order to delay the modulating action of the modulating agent on the first enzyme. Alternatively, the modulating agent is placed inside a time release particle to delay the modulating action of the second enzyme on the first enzyme.

Detergent materials used typically will include a surface active agent, i.e., surfactant, including anionic, non-ionic and ampholytic surfactants well known for their use in detergent compositions.

Suitable anionic surfactants for use in the detergent composition of this invention include linear or branched alkylbenzenesulfonates; alkyl or alkenyl ether sulfates having linear or branched alkyl groups or alkenyl groups; alkyl or alkenyl sulfates; olefinsulfonates; alkane-sulfonates and the like. Suitable counter ions for anionic surfactants include alkali metal ions such as calcium and magnesium; ammonium ion; and alkanolamines having 1 to 3 alkanol groups of carbon number 2 or 3.

Ampholytic surfactants include quaternary ammonium salt sulfonates, betaine-type ampholytic surfactants, and the like. Such ampholytic surfactants have both the positive and negative charged groups in the same molecule.

Non-ionic surfactants generally comprise polyoxyalkylene ethers, as well as higher fatty acid alkanolamides or alkylene oxide adduct thereof, fatty acid glycerine monoesters, and the like.

Examples of other suitable surfactants include conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)ₓ(CHOSO₃⁻M⁺)CH₃ and CH₃(CH₂)_{y}(CHOSO₃⁻M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AEₓS”; especially EO 1-7 ethoxy sulfates), C₁₀-C₁₈ alkyl alkoxy carboxylates (especially the EO 1-5 ethoxycarboxylates), the C₁₀-C₁₈ glycerol ethers, the C₁₀-C₁₈ alkyl polyglycosides and their corresponding sulfated polyglycosides, and C₁₂-C₁₈ alpha-sulfonated fatty acid esters. If desired, the conventional non-ionic and amphoteric surfactants such as the C₁₂-C₁₈ alkyl ethyoxylates (“AE”) including the so-called narrow peaked alkyl ethyoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like, can also be included in the overall compositions. The C₁₀-C₁₈ N-alkyl polyhydroxy fatty acid amides can also be used. Typical examples include the C₁₂-C N-methylglucamides. Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and non-ionic surfactants are especially useful. Bile salts and their derivatives are other examples of surfactants.

The compositions and methods employing the effervescent system provide for enhanced dissolution of materials as compared to materials not comprising the effervescent system. In this regard, the amount of residue remaining at any point in time after a material is placed in a liquid is a measure of the effectiveness of the dissolution process and, accordingly, compositions exhibiting high levels of residue are commercially not favored.

When enzymes and substrates are employed as the effervescent system, compositions will typically comprise from about 0.001% to about 50% and preferably, from about 5% to about 30% most preferably, from about 0.25% to about 20% by weight of the enzymes and substrates. (All percentages herein are based on weight unless indicated otherwise).

### EXAMPLES

The following examples are offered to illustrate this invention and are not to be construed in any way as limiting the scope of the invention.

In the examples below, the following abbreviations have the following meanings. If an abbreviation is not defined, it has its generally accepted meaning.

cm=centimeter

cfm=cubic feet per minute

g=gram

HPMC=hydroxypropylmethylcellulose

L=liters

min.=minutes

mL=milliliter

mm=millimeter

mM=millimolar

nm=nanometer

OD=optical density

PEG=polyethylene glycol

psi=pounds per square inch

rpm=rotations per minute

uL=microliters

um=micron

umole=micromole

UV=ultraviolet

NEODAL=NEODAL 23/6.5 (Shell Chemical)

In one or more of the following examples, certain terms are used which terms are defined in detail below:

Definition of Catalase Activity Units:

Catalase international activity units, IU, are defined and measured as follows using a modified Bergmeyer method (1) H. U. Bergmeyer, Biochem.Z. (1955), 327, p255, 2) H. Luck, in Methods of Enzymatic Analysis (H. U. Bergmeyer, ed.), (1965), p885-894, Verlag Chemie & Academic Press, New York/London). The assay is based on following the decomposition of hydrogen peroxide at 240 nm, pH 7, 25° C. The time required for the absorbance to decrease 0.05 OD units, during the linear phase of the assay, is a measure of the catalase activity. One unit is the amount of enzyme that will decompose 1 umole of hydrogen peroxide per min., under the conditions of the assay.

Assay: Substrate preparation: Approximately 0.103 mL of 30% hydrogen peroxide (ACS grade) are pipetted into a 25 mL volumetric flask and mixed with 50 mM potassium phosphate buffer, pH 7.0, at room temperature, to a final volume of 25 mL. The absorbance of this solution at 240 nm should be approximately 1.50 OD units against a buffer blank and adjusted to this range with hydrogen peroxide, if needed. This solution should be made fresh at least daily.

Enzyme preparation/dilution: The enzyme solution is diluted to an activity value of 3000 to 500 IU/ml with phosphate buffer.

Test procedure: The wavelength of a spectrophotometer is set to 240 nm after the UV lamp has been turned on for at least 30 min. The absorbance of a 3 mL solution of phosphate buffered substrate, in a 3 mL quartz cuvette, should be approximately 1.50 OD units against a buffer blank. 20-50 uL of diluted enzyme are pipetted into the cuvette and the contents of the cuvette, covered by a piece of parafilm, are mixed by gentle inversion. The cuvette is placed back in the cuvette holder and the absorbance is monitored. The completion of the run occurs as soon as the absorbance drops by 0.05 OD units. The mean initial time (ti) is noted, as well as the mean final time (tf), when the absorbance drops by 0.05 OD units from the intial time (ti); these times are added to a spreadsheet, as well as the sample volume (IV) and dilution factor of the sample (DF); this spreadsheet, which takes into account the constant for activity in Bergmeyer units (K_{B}) and the factor for conversion of Bergmeyer units into international units (K_{M}), enables one to calculate the difference in time (t=tf−ti) and provide the activity of the sample in terms of international units:

$$Activity = \frac{( {K}_{B} ) ( {K}_{M} )}{( DF ) ( IV ) ( t )} IU \text{/} mL$$

Measurement of Activity in Granule and Powder Samples:

Typically 1 g of granule/powder sample is dissolved with deionized water (final weight is 50 g) in a 50 mL conical tube. The tube is capped and placed on a rotating shaker for a minimum of an hour to mix at moderate speed at room temperature, with care being given so as not to make bubbles during agitation. The activity of the sample is determined on an aliquot of this solution, using the standard protocol described above.

Dissolution Tests for Granules, Powders, and Tablets:

Examples of dissolution assays for granules and powders made with granules:

Example of a filtration assay:

1 g of powder or granule sample are placed in a 2L beaker containing a magnetic stir bar. 1L of water, equilibrated at 10° C, is added. The contents of the beaker are stirred under medium agitation (300 rpm approx.) for 10 min., after which the stir bar is removed. The beaker contents are quickly poured onto a pre-weighed (pi) Whatman 42 filter paper (2.5 um pore size) in a Buchner funnel under vacuum; only particles of diameter size less than 2.5 um are able to pass through this type of filter. The beaker is rinsed with a total of 20 mL of water, which are added to the Buchner funnel. The filter paper is pulled off using tweezers and placed in a semi-covered Petri dish to dry overnight in an oven at 37° C. The Petri dish, is then covered and cooled to room temperature for at least two hours before the filter paper, containing the sample residue, is weighed (pf). The difference in weight pf-pi corresponds to the weight of the insoluble residue for that particular sample. The amount of residue on Whatman 42 is an indication of the amount of total residue produced by a sample (including both fine and coarse particles); the filtrate is optically clear to the eye.

An identical experiment is performed on a sample using a pre-tared (pi) Whatman 541 filter paper (25 um pore size). The porosity of this type of filter is larger and enables one to analyze residue comprised of coarser or larger type particles, not able to pass through a 25 um diameter sized pore. The weight of the residue is obtained by measuring the difference in weight between that of the filter paper with residue (pf) and that of the initial paper filter (pi).

For both cases of filter paper porosity, the residue weights from the enzyme containing samples are compared to those of the corresponding control samples without enzyme and the corresponding detergent matrix. The ratio of the residue weight on the larger pore size filter paper (Whatman 541) was also determined to that on the smaller pore size filter paper (Whatman 42) for any given sample; the ratio 541/42 is an indication of the relative amount of coarse or large particle size insoluble matter to total insoluble matter (containing both fine and coarse particles) obtained after dissolution for any given sample. It is compared to that of the non-enzyme control and the detergent matrix reference sample.

Digital images of the swatches are also generated and quantification of the residue is determined by image analysis of these digital images. Each pixel of an image is assigned a greyscale value (or intensity value) from which the brightness of that pixel is derived. Absolute black pixels are defined as 0 and absolute white pixels are 255. Since the residue of samples is white and the fabric is dark, then a quantification of the residue can be calculated using the greyscale values from an image of a sample treated swatch. Images are generated using a Bio-Rad Gel Doc 1000 with a digital camera and a H6X8-II 8-48 mm 1:1.0 Zoom Lens connected to a computer running the Bio-Rad “Multi-Analyst” program. 7.5 cm×10 cm tiff images of the swatches are created at a resolution of 163 pixels/inch. An average greyscale value of the swatch in an image is then calculated using the volume report tool in Molecular Dynamic's “ImageQuant” program. Background values are calculated for untreated swatches and subtracted from values calculated for sample treated swatches to obtain a normalized average greyscale value for the sample treated swatch. These normalized values represent the amount of residue from a sample visualized on a fabric swatch, where higher values indicate larger amounts of residue. Background greyscale values for untreated swatches are typically around 73 and samples depositing large amounts of residue typically have average values of 100. Therefore, a sample's normalized greyscale values around 5 are very low in residue and values around 25 contain a significant amount of residue. Normalized values from all samples and controls can be compared as long as treatment of the swatches with each sample is consistent.

Examples of Dissolution Assays for Tablets:

A tablet is placed in a beaker containing 1.5 L of deionized water at 10° C. and left to sit for 5 min. during which time visual estimation of the bubbling is made. The contents are then poured into a Terg-o-tometer pot. The beaker is rinsed with 100 mL of deionized water, twice, which is also poured into the Terg-o-tometer pot, then the entire contents are mixed at 125 rpm for 10 min. The resulting mixture is poured onto a pre-weighed Whatman 541 filter paper in a Buchner funnel under vacuum. The Terg-o-tometer pot is rinsed with 20 mL of deionized water, which is added to the Buchner funnel. The filter paper is pulled off using tweezers and placed in a semi-covered Petri dish to dry overnight in an oven at 37° C. The Petri dish, is then covered and cooled to room temperature for at least two hours before the filter paper, containing the sample residue, is weighed. Residue from the dissolution of tablets is determined and compared in the same manner as the residue from the powder samples in the filtration assay. Grading of the bubbling is done on a scale from (−−−−−) to (+++++), where (−−−−−) represents no bubbling and (+++++) represents a vigorous bubbling that causes parts of the tablet to break off.

Fizzing assay: This procedure qualitatively measures the gas producing or “fizzing” capabilities compositions when placed in an aqueous solution. A Kenmore 80 Series washing machine is filled to 4 gallons with 90° C. water. The water hardness is titrated for calcium and magnesium and then adjusted to 6 gpg. The washing machine is started so that water was falling into the wash basket, then immediately a 62.75 g scoop of sample containing detergent and an effervescent system is poured into the washing machine with a large swooping motion. A grade is immediately assigned for the amount of fizzing produced by the sample. A minimum grade of 35 is considered by consumers to be a true signal of fizzing. The optimum amount of fizzing has been determined to be a grade of 35 within 5 to 10 seconds.

Foam imaging assay: This procedure visually measures the foaming capabilities compositions when placed in an aqueous solution. Samples are placed in a dish containing 400 mL of deionized distilled water where the water hardness is titrated for calcium and magnesium and then adjusted to 6 gpg. Upon dissolving in the aqueous solution, each composition generates foam on the surface of the dish. A video image of the top surface of the dish after 10 seconds is taken. The image is then quantitatively analyzed to determine the surface area of the dish which is covered with foam.

The following Examples 1-17 illustrate various embodiments of solid compositions containing an effervescent system.

### Example 1

This example describes a detergent tablet containing an enzyme and enzyme substrate effervescent system and a second enzyme to modulate the activity of the first enzyme. A tablet can be formed from the following components:

a. 1% of catalase from A. niger having 1 MU (megaunit) of activity per gram of catalase;

b. 1% of granulated protease from Bacillus cetelus having 4 MU (megaunit) of activity per gram of protease;

c. 5% sodium perborate;

d. 15% surfactant (1:1 of non-ionic to anionic surfactant);

e. 20% monobasic sodium phosphate; and

f. balance builder (sodium tripolyphosphate).

The components are combined in dry form and mixed until homogeneous. Approximately 40 grams of the homogeneous mixture is then pressed into tablet form using a conventional tablet presser under sufficient pressure to provide a hardness of 80 to 100 Newtons in the finish tablet.

### Example 2

This example describes a detergent tablet that includes an enzyme and enzyme substrate that functions as an adjunct to an citrate/sodium bicarbonate mixture. A tablet can be formed from the following components using the same procedure as in Example 1:

a. 20% sodium bicarbonate;

b. 1% of carbonic anhydrase available from Sigma Chemical Company, St. Louis, Mo., USA having 10,000 W-A units of activity;

c. 15% surfactant (1:1 of non-ionic to anionic surfactant);

d. 5% citric acid; and

e. balance builder (sodium tripolyphosphate).

### Example 3

This example describes a detergent tablet that employs an iron (Fe⁺² and Fe⁺³) catalyst and a perborate effervescent system. A tablet can be formed from the following components using the same procedure as in Example 1:

a. 20% sodium bicarbonate;

b. 1% of FeSO_{4;}

c. 15% surfactant (1:1 of non-ionic to anionic surfactant);

d. 5% sodium perborate; and

e. balance builder (sodium tripolyphosphate).

Other components can be employed in conjunction with the tablets of Examples 1-3 above including disintegrants such as cross-linked polyacrylates, sodium citrate, sodium acetate, cellulosic polymers and the like; perfumes; buffers such as disilicates, binders such as starch and surfactants and the like.

In the following Examples 4-9, various embodiments of the solid composition that contain the effervescent system are prepared and tested against comparative solid compositions.

### Example 4

In this example, the dissolution rates of detergent mixtures containing perborate and granules (1A) which comprised a core, a first enzymatic layer, and a second barrier layer were compared to those containing comparative granules (1B) which did not include the second barrier layer.

Granule 1A was prepared as follows

600 g of nonpareils were charged into a Vector FL-1 fluid bed coated and fluidizer. 7000 g of Micrococcus luteus catalase with 16.4% total dry solids and an activity of 1,600,000 IU/mL were sprayed onto the nonpareils under the following conditions:

| | |
|---|---|
| Fluid feed rate: | 11 g/min |
| Atomization air pressure: | 40 psi |
| Inlet air temperature: | 80° C. |
| Outlet air temperature: | 40° C. |
| Inlet air rate: | 70 cfm |

The coated granules were then coated with 414 g of an aqueous solution containing 18.2 grams of HPMC and 2.5 g of PEG (600 MW). The solution was sprayed onto the coated granules under the following conditions:

| | |
|---|---|
| Fluid feed rate: | 13 g/min |
| Atomization pressure: | 50 psi |
| Inlet air pressure: | 100° C. |
| Outlet air pressure: | 47° C. |
| Inlet air rate: | 70 cfm. |

The final activity on the granules was 8,238,885 IU/g. Composition of powder incorporating granule 1A contained 0.3 g granule 1A, 0.561 g perborate, and 29.139 g commercial detergent.

The powders were weighed and then placed on an Appropriate Technical Resources Inc (ATR) RKVS rotating mixer at 30 rpm for twenty minutes.

Granule 1B was prepared as follows.

1200 g of nonpareils were charged into a Vector FL-1 fluid bed coated and fluidizer. 827.9 g of an aqueous solution containing 36.9 g of HPMC and 4.41 g of PEG (600 MW) was applied to the cores under the following conditions:

| | |
|---|---|
| Fluid feed rate: | 13 g/min |
| Atomization pressure: | 50 psi |
| Inlet air temperature: | 100° C. |
| Outlet air temperature: | 47° C. |
| Inlet air rate: | 70 cfm |

Composition of powders incorporating granules 1B contained 0.3 g granule 1B, 0.561 g perborate, and 29.139 g commercial detergent.

The powders were weighed and then placed on an Appropriate Technical Resources Inc (ATR) RKVS rotating mixer at 30 rpm for twenty minutes.

The dissolution data in Table 1 demonstrates that the compositions comprising catalase and a suitable substrate have less residue than compositions with the catalase only and have less residue than commercial detergent alone and, accordingly, the presence of catalase and substrate are seen as facilitating the dissolution of the compositions.

TABLE 1

| | | in Powder | | |
|---|---|---|---|---|
| | | Whatman 541 | Whatman 42 | |
| | | Mean weight of | Mean weight of | 541/42 |
| Samples Containing | Catalase | residue (g)* | residue (g)* | ratio |
| Granule 1A | Yes | 0.3360 | 0.3936 | 0.8535 |
| Granule 1B | No | 0.3566 | 0.4031 | 0.8845 |
| Commercial | No | 0.4270 | 0.4526 | 0.9433 |
| detergent reference | | | | |

*The mean weight residue represents the mean of two or more replicates.

### Example 5

In this example, the dissolution rates of powders containing perborate and prepared from granules (2A) which comprised a core, a first enzymatic layer, a second barrier layer, and a third enzymatic substrate layer were compared to those prepared from comparative granules (2B) which did not include the first enzymatic layer.

Granule 2A was prepared as follows

95 g of granules from Granule 1A (set forth in Example 4) were loaded into a Glatt Air Uniglatt fluid bed coated and fluidizer. The granules were then coated with 118.8 g of an aqueous solution containing 5.3 g of HPMC and 0.64 g of PEG (600 MW) under the following conditions.

| | |
|---|---|
| Fluid feed rate: | 4.5 g/min |
| Atomization pressure: | 30 psi |
| Inlet air temperature: | 60° C. |
| Outlet air temperature: | 40° C. |
| Inlet air rate: | 30 cfm |

The coated granules were then coated with 22 g of an aqueous solution containing 2.2 g of sodium perborate monohydrate. The sodium perborate monohydrate solution was applied under the following conditions:

| | |
|---|---|
| Fluid feed rate: | 4.5 g/min |
| Atomization pressure: | 30 psi |
| Inlet air temperature: | 60° C. |
| Outlet air temperature: | 40° C. |
| Inlet air rate: | 30 cfm |

The final activity of the granules was 5,409,322 IU/g.

Powder composition from granule 2A were weighed and then placed on an Appropriate Technical Resources Inc (ATR) RKVS rotating mixer at 30 rpm for twenty minutes. Table 2 provides the components of the powders made.

TABLE 2

| | wt. (g) | | |
|---|---|---|---|
| | Granule | wt. (g) | |
| Powder and Tablet # | 2A | perborate | wt. (g) commercial detergent |
| 1 | 0.0015 | 0.561 | 29.438 |
| 2 | 0.015 | 0.561 | 29.424 |
| 3* | 0.3 | 0.561 | 29.139 |

*Powder shown in comparative dissolution data

Comparative Granule 2B was prepared as follows:

95 g of granules from Comparative Granule 1B (as set forth in Example 4) were loaded into a Glatt Air Uniglatt fluid bed coater and fluidizer. These granules were coated with 118.8 g of an aqueous solution containing 5.3 g of HPMC and 0.64 g of PEG (600 MW) were applied to the granules under the following conditions:

| | |
|---|---|
| Fluid feed rate: | 4.5 g/min |
| Atomization pressure: | 30 psi |
| Inlet air temperature: | 60° C. |
| Outlet air temperature: | 40° C. |
| Inlet air rate: | 30 cfm |

The coated granules were then coated with 22 g of an aqueous solution containing 2.2 g of sodium perborate monohydrate. The sodium perborate monohydrate solution was applied under the following conditions:

| | |
|---|---|
| Fluid feed rate: | 4.5 g/min |
| Atomization pressure: | 30 psi |
| Inlet air temperature: | 60° C. |
| Outlet air temperature: | 40° C. |
| Inlet air rate: | 30 cfm |

Powder compositions from granule 2B were weighed and then placed on an Appropriate Technical Resources Inc (ATR) RKVS rotating mixer at 30 rpm for twenty minutes. Table 3 provides the components of the powders made.

TABLE 3

| Powder and | wt. (g) | wt. (g) | |
|---|---|---|---|
| Tablet # | Granule 2B | perborate | wt. (g) commercial detergent |
| 1 | 0.0015 | 0.561 | 29.438 |
| 2 | 0.015 | 0.561 | 29.424 |
| 3* | 0.3 | 0.561 | 29.139 |

*Powder and Tablet shown in comparative dissolution data.

The dissolution data in Table 4 demonstrate that the compositions comprising catalase and a suitable substrate have less residue than compositions with the substrate only and have less residue than the commercial detergent alone and, accordingly, the presence of catalase and substrate are seen as facilitating the dissolution of the composition.

TABLE 4

| | | Whatman 541 | Whatman 42 | |
|---|---|---|---|---|
| Samples | | Mean weight of | Mean weight of | |
| Containing | Catalase | residue (g) * | residue (g) * | 541/42 ratio |
| Granule 2A | Yes | 0.3593 | 0.4014 | 0.8951 |
| Granule 2B | No | 0.3836 | 0.3844 | 0.9978 |
| Commercial | No | 0.4270 | 0.4526 | 0.9433 |
| Detergent | | | | |
| Reference | | | | |

* The mean weight residue represents the mean of two or more replicates

### Example 6

In this example, the dissolution rates of powders containing perborate and prepared from granules (3A) which comprised a detergent core, a first enzymatic layer, a second barrier layer, and a third enzymatic substrate layer were compared to those prepared from comparative granules (3B) which did not include the first enzymatic layer.

Granule 3A was prepared as follows:

200 g of laundry detergent were charged into a Glatt Air Uniglatt fluid bed coater and fluidizer. 35.838 g of water were mixed with 0.362 mL of Micrococcus luteus catalase with 16.4% total dry solids and an activity of 1,600,000 IU/mL and applied under the following conditions:

| | | |
|---|---|---|
| Fluid feed rate: | 6.8 | g/min. |
| Atomization pressure: | 20 | psi |
| Inlet air temperature: | 60° | C. |
| Outlet air temperature: | 40° | C. |
| Inlet air rate: | 30 | cfm |

The coated granules were then further coated with 146.6 g of an aqueous solution containing 6.054 g of HPMC and 0.726 g of PEG (600 MW) and applied under the following conditions:

| | | |
|---|---|---|
| Fluid feed rate: | 4.5 | g/min |
| Atomization pressure: | 30 | psi |
| Inlet air temperature: | 60° | C. |
| Outlet air temperature: | 40° | C. |
| Inlet air rate: | 30 | cfm |

Powder compositions of granule 3A were weighed and then placed on an Appropriate Technical Resources Inc (ATR) RKVS rotating mixer at 30 rpm for twenty min. A tablet containing 0.561 g of sodium perborate and 29.439 g of granule 3A was prepared. The mixture of ingredients was added to a Stokes Model R4 single station tablet press and compressed to a hardness between 30-40 N as measured by a modified Dr. Schleuniger Pharmatron, Inc. 6D tablet hardness tester. The resulting tablet was cylindrical, weighed 30 g with a diameter of 44.1 mm and a thickness of 18.01 mm.

Comparative Granule 3B was prepared as follows:

200 g of laundry detergent were charged into a Glatt Air Uniglatt fluid bed coater and fluidizer and were then coated with 146.6 g of an aqueous solution containing 6.054 g of HPMC and 0.726 g of PEG (600 MW) and applied under the following conditions:

| | | |
|---|---|---|
| Fluid feed rate: | 4.5 | g/min |
| Atomization pressure: | 30 | psi |
| Inlet air temperature: | 60° | C. |
| Outlet air temperature: | 40° | C. |
| Inlet air rate: | 30 | cfm |

Powder compositions of granules 3B were weighed and then placed on an Appropriate Technical Resources Inc (ATR) RKVS rotating mixer at 30 rpm for twenty minutes. A tablet containing the 0.561 g of sodium perborate and 29.439 g of granule 3B was prepared. The mixture of ingredients was added to a Stokes Model R4 single station tablet press and compressed to a hardness between 30-40 N as measured by a modified Dr. Schleuniger Pharmatron, Inc. 6D tablet hardness tester. The resulting tablet was cylindrical, weighed 30 g with a diameter of 44.1 mm and a thickness of 18.01 mm.

The dissolution data in Table 5 demonstrates that powders and tablets containing perborate and prepared from granules which comprised a detergent core, a catalase layer, a second barrier layer, and a third enzymatic substrate layer have less residue than those prepared from comparative granules which did not include the catalase and have less residue than commercial detergent samples. In addition, the catalase and substrate are seen to produce a bubbling effect which can be a recognizable signal of gas release.

TABLE 5

| | | | | | in Tablet | |
|---|---|---|---|---|---|---|
| | | in Powder | | | Whatman | |
| | | Whatman 541 | Whatman 42 | | 541 | |
| | | Mean weight | Mean weight | | Weight of | Bubbling |
| Samples | | of residue | of residue | 541/42 | Tablet | Rate |
| Containing | Catalase | (g) * | (g) * | ratio | Residue (g) | of Tablet |
| Granule 3A | Yes | 0.3206 | 0.3877 | 0.8270 | 11.00 | ++ |
| Granule 3B | No | 0.3651 | 0.3856 | 0.9470 | 15.88 | |
| Commercial | No | 0.4270 | 0.4526 | 0.9433 | 17.79 | −−− |
| detergent | | | | | | |
| Reference | | | | | | |

* The mean weight residue represents the mean of two or more replicates

### Example 7

In this example, the dissolution rates of powder containing perborate and prepared from granules (4A) which comprised a first enzymatic layer, a second reaction barrier layer, and a third detergent layer were compared to those prepared from comparative granules (4B) which did not include the first enzymatic layer.

Granule 4A was prepared as follows:

927 g of nonpareils were charged into a Vector FL-1 fluid bed coater and fluidizer. 322 g of Micrococcus luteus catalase with 16.4% total dry solids and an activity of 1.6 MIU/mL were sprayed onto the nonpareil under the following conditions:

| | | |
|---|---|---|
| Fluid feed rate: | 11 | g/min |
| Atomization pressure: | 40 | psi |
| Inlet air temperature: | 80° | C. |
| Outlet air temperature: | 40° | C. |
| Inlet air rate: | 70 | cfm |

The coated granules were then coated with 658 g of an aqueous solution containing 29.4 g of HPMC and 3.5 g of PEG (600 MW). The solution was sprayed under the following conditions:

| | | |
|---|---|---|
| Fluid feed rate: | 13 | g/min |
| Atomization pressure: | 50 | psi |
| Inlet air temperature: | 100° | C. |
| Outlet air temperature: | 47° | C. |
| Inlet air rate: | 70 | cfm |

The final activity on the granules was 763,406 IU/g.

500 g of granules from the above run were charged into a Vector FL-1 fluid bed coater and fluidizer. 88 g of laundry detergent was mixed with 589 g of water. The solution was applied under the following conditions:

| | | |
|---|---|---|
| Fluid feed rate: | 20 | g/min. |
| Atomization pressure: | 40 | psi |
| Inlet air temperature: | 80° | C. |
| Outlet air temperature: | 50° | C. |
| Inlet air rate: | 70 | cfm |

The final activity on the granules was 228,223 IU/g.

Powder compositions made from the granule 4A were weighed and then placed on an Appropriate Technical Resources Inc (ATR) RKVS rotating mixer at 30 rpm for twenty minutes. Eight tablets containing the amounts of commercial detergent, sodium perborate and granule 4A as set forth in Table 6 were prepared. The mixture of ingredients was added to a Stokes Model R4 single station tablet press and was compressed to a hardness of between 30-40 N as measured by a modified Dr. Schleuniger Pharmatron, Inc. 6D tablet hardness tester. The resulting tablet was cylindrical, weighed 30 g with a diameter of 44.1 mm and a thickness of 18.01 mm.

TABLE 6

| Powder and | wt. (g) | wt. (g) | |
|---|---|---|---|
| Tablet # | Granule 4A | perborate | wt. (g) commercial detergent |
| 1 | 0.0015 | 0.561 | 29.438 |
| 2 | 0.015 | 0.561 | 29.424 |
| 3 | 0.3 | 0.561 | 29.139 |
| 4 | 0.021 | 0.561 | 29.418 |
| 5 | 0.21 | 0.561 | 29.229 |
| 6 | 4.2 | 0.561 | 25.239 |
| 7 | 3 | 0.561 | 26.439 |
| 8* | 6 | 0.561 | 23.439 |

*Powder and Tablet shown in comparative dissolution data.

Comparative Granule 4B was prepared as follows:

1200 g of nonpareil cores were charged into a Vector FL-1 fluid bed coater and fluidizer. 827.9 g of an aqueous solution containing 36.9 g of HPMC and 4.41 g of PEG (600 MW) were applied under the following conditions:

| | | |
|---|---|---|
| Fluid feed rate: | 13 | g/min |
| Atomization pressure: | 50 | psi |
| Inlet air temperature: | 100° | C. |
| Outlet air temperature: | 47° | C. |
| Inlet air rate: | 70 | cfm |

500 g of the granules from the above run were charged into a Vector FL-1 fluid bed coater and fluidizer. 88 g of laundry detergent were mixed with 589 g of water. The solution was applied under the following conditions:

| | |
|---|---|
| Fluid feed rate: | 20 g/min |
| Atomization pressure: | 40 psi |
| Inlet air temperature: | 80° C. |
| Outlet air temperature: | 50° C. |
| Inlet air rate: | 70 cfm |

Powder made from granule 4B were weighed and then placed on an Appropriate Technical Resources Inc (ATR) RKVS rotating mixer at 30 rpm for twenty minutes. Eight tablets containing the amounts of commercial detergent, sodium perborate and Granule 4B as set forth in Table 7 were prepared. The mixture of ingredients was added to a Stokes Model R4 single station tablet press and was compressed to a hardness between 30-40 N as measured by a modified Dr. Schleuniger Pharmatron, Inc. 6D tablet hardness tester. The resulting tablet was cyclindrical, weighed 30 g with a diameter of 44.1 mm and a thickness of 18.01 mm.

TABLE 7

| Powder and | wt. (g) | | Wt. |
|---|---|---|---|
| Tablet # | Granule 4B | wt. (g) perborate | (g) commercial detergent |
| 1 | 0.0015 | 0.561 | 29.438 |
| 2 | 0.015 | 0.561 | 29.424 |
| 3 | 0.3 | 0.561 | 29.139 |
| 4 | 0.021 | 0.561 | 29.418 |
| 5 | 0.21 | 0.561 | 29.229 |
| 6 | 4.2 | 0.561 | 25.239 |
| 7 | 3 | 0.561 | 26.439 |
| 8* | 6 | 0.561 | 23.439 |

*Powder and Tablet shown in comparative dissolution data.

The dissolution data in Table 8 demonstrate that powders and tablets containing perborate and prepared from granules which comprised a catalase layer, a second barrier layer, and a third detergent layer have less residue than those prepared from comparative granules which did not include the catalase and have less residue than commercial detergent samples. In addition, the catalase and substrate are seen to produce a bubbling effect which can be a recognizable signal of gas release.

TABLE 8

| | | in Powder | | | | in Tablet | |
|---|---|---|---|---|---|---|---|
| | | | | | Tablet | Whatman | |
| | | Whatman | Whatman | | Powder | 541 | |
| | | 541 Mean | 42 Mean | | Residue | Weight | |
| | | weight of | weight of | | Normalized | of tablet | Bubbling |
| Samples | | residue | residue | 541/42 | Greyscale | residue | Rate of |
| Containing | Catalase | (g)* | (g)* | ratio | Value | (g) | Tablet |
| Granule 4A | Yes | 0.3200 | 0.3348 | 0.9556 | 17.295 | 14.47 | ++++ |
| Granule 4B | No | 0.3677 | 0.3534 | 1.0403 | 17.800 | 14.89 | − |
| Commercial | No | 0.4270 | 0.4526 | 0.9433 | 20.687 | 17.79 | −−− |
| Detergent | | | | | | | |
| Reference | | | | | | | |

*The mean weight residue represents the mean of two or more replicates

### Example 8

In this example, the dissolution rates of tablets containing a commercial detergent, perborate and granules (SA) which comprised a detergent and an enzyme were compared to those prepared from comparative granules (5B) which did not include the enzyme.

Preparation of Detergent 5A

410 g of alcohol ethyoxylate sulfate (AES) was mixed with 410 g of Micrococcus luteus catalase with 16.4% total dry solids and an activity of 1,600,000 IU/mL. 250 g of the mix was placed in a lyophilizer over a three-day period. The mix was then ground into a powder. The final activity of the detergent was 1,751,155 IU/g.

Preparation of Comparative Detergent 5B

250 g of alcohol ethyoxylate sulfate (AES) was placed in a lyophilizer over a three day period. It was then ground into a power.

Powders comprising granule 5A were weighed and then placed on an Appropriate Technical Resources Inc (ATR) RKVS rotating mixer at 30 rpm for twenty minutes.

One tablet containing 26.439 g of commercial detergent, 0.561 g of sodium perborate and 3.852 g of detergent 5A was prepared. The mixture of ingredients was added to a Stokes Model R4 single station tablet press and was compressed to a hardness between 30-40 N as measured by a modified Dr. Schleuniger Pharmatron, Inc. 6D tablet hardness tester. The resulting tablet was cylindrical, weighed 30 g with a diameter of 44.1 mm and a thickness of 18.01 mm. An identical tablet containing the same ingredients, except that 3 g of detergent 5B was used, was made.

The dissolution data in Table 9 demonstrates that powders and tablets that contained a commercial detergent, perborate and granules which comprised a detergent and a catalase have less residue than those prepared from comparative granules which did not include the catalase and less residue than commercial detergent samples. In addition, the catalase is seen to produce a bubbling effect which can be a recognizable signal of gas release.

TABLE 9

| | | in Powder | | | | | |
|---|---|---|---|---|---|---|---|
| | | | | | Tablet | in Tablet | |
| | | | | | Powder | Whatman | |
| | | Whatman | | | Residue | 541 | |
| | | 541 | Whatman 42 | | Normal- | Weight | |
| | | Mean weight | Mean weight | | ized | of tablet | Bubbling |
| Samples | | of residue | of residue | 541/42 | Greyscale | residue | Rate |
| Containing | Catalase | (g)* | (g)* | ratio | Value | (g) | of Tablet |
| Detergent 5A | Yes | 0.2475 | 0.2999 | 0.8253 | 8.861 | 17.37 | ++++ |
| | | | | | | | + |
| Detergent 5B | No | 0.3638 | 0.3952 | 0.9207 | 9.727 | 19.70 | |
| Commercial | No | 0.4270 | 0.4526 | 0.9433 | 20.687 | 17.79 | −−− |
| Detergent | | | | | | | |
| Reference | | | | | | | |

*The mean weight residue represents the mean of two or more replicates.

### Example 9

5 In this example, the dissolution rates of powder containing (i) perborate, (ii) a commercial detergent base, and (iii) a detergent (6A) which comprised a mixture of enzyme, zeolite and LAS were compared to those prepared from comparative granules (6B) which did not include the enzyme.

Detergent 6A was prepared as follows:

0.41 g of sodium sulfate anhydrous, 12 g of water, 0.54 g of Micrococcus luteus catalase with 16.4% total dry solids and an activity of 1,600,000 IU/mL, 50 g of zeolite and 10 g of linear alkyl benzene sulfonate (LAS) were mixed to form agglomerates. The mix was then placed in a vacuum oven with no heat over night.

Powders comprising 7.35 g detergent 6A, 0.561 g perborate, and 22.08 g of a detergent base, were weighed and then placed on an Appropriate Technical Resources Inc (ATR) RKVS rotating mixer at 30 rpm for twenty minutes. The detergent base is a detergent mix containing LAS, AE3S, AS zeolite, Sodium polyacrylate (4500 MW), sodium oxydisuccinate, sodium silicate (1.6 ratio), brightener, PEG 8000, sodium carbonate, sodium sulfate, moisture and antifoam. See, for example, U.S. Pat. No. 5,108,646, which is incorporated herein by reference.

Comparative Detergent 6B was prepared as follows:

0.41 g of sodium sulfate anhydrous, 12.5 g of water, 50 g of zeolite and 10 g of linear alkyl benzene sulfonate (LAS) were mixed to form agglomerates. The mixture was then placed in a vacuum oven with no heat over night.

Powders comprising 7.35 g detergent 6B, 0.561 g perborate and 22.08 g of base detergent, were weighed and then placed on an Appropriate Technical Resources Inc (ATR) RKVS rotating mixer at 30 rpm for twenty minutes.

The dissolution data in Table 10 demonstrate that powders containing (i) perborate, (ii) a commercial detergent base, and (iii) a detergent which included catalase have less residue than those prepared from comparative detergent which did not include the catalase and have less residue than commercial detergent samples. In addition, the catalase and substrate are seen to produce a bubbling effect which can be a recognizable signal of gas release.

TABLE 10

| | | in Powder | | |
|---|---|---|---|---|
| | | Whatman 541 | Whatman 42 | |
| Samples | | Mean weight | Mean weight | |
| Containing | Catalase | of residue (g)* | of residue (g)* | 541/42 ratio |
| Detergent | Yes | 0.3652 | 0.4796 | 0.7614 |
| 6A | | | | |
| Detergent | No | 0.3950 | 0.5025 | 0.7860 |
| 6B | | | | |
| Commercial | No | 0.4270 | 0.4526 | 0.9433 |
| detergent | | | | |
| reference | | | | |

*The mean weight residue represents the mean of two or more replicates

### Example 10

Co-granules having an enzyme substrate core, a first reaction barrier layer, a second enzyme layer, and a third protective coat as shown in FIG. 2 were prepared as follows:

180 g of sodium perborate monohydrate was added to a Glatt Air Uniglatt fluid bed coater and fluidizer. 235.29 g of an aqueous solution containing 11.76 g of titanium dioxide, 9.41 g of sucrose and 2.35 g of NEODOL and applied using the following conditions:

| | |
|---|---|
| Fluid feed rate | 10 g/min |
| Atomization pressure | 40 psi |
| Inlet air temperature | 35° C. |
| Outlet air Temperature | 24° C. |
| Inlet air rate | 45 cfm |

The coated particles were then coated with 69.4 g Micrococcus luteus catalase with 20.9% total dry solids and an activity of 3,865,290 IU/ml and applied using the following conditions:

| | |
|---|---|
| Fluid feed rate | 19 g/min |
| Atomization pressure | 40 psi |
| Inlet air temperature | 34° C. |
| Outlet air Temperature | 22° C. |
| Inlet air rate | 45 cfm |

93.2 g of the coated particles were then coated with 80 g of an aqueous solution containing 4 g of titanium dioxide, 3.2 g of sucrose and 0.8 g of NEODOL and applied using the following conditions:

| | |
|---|---|
| Fluid feed rate | 10 g/min |
| Atomization pressure | 40 psi |
| Inlet air temperature | 35° C. |
| Outlet air Temperature | 24° C. |
| Inlet air rate | 45 cfm |

### Example 11

A granule system comprising a substrate granule and an enzyme granule having a modulating agent core, a first reaction barrier layer, second enzyme layer, and a third protective coat is shown in FIG. 3. Enzyme granules were prepared as follows:

1594 g of sodium sulfate cores were charged into a Vector FL-1 fluid bed coater and fluidizer. 1956.9 g of protease concentrate from Bacilus subtilis with 24.4% total dry solids and an activity of 101 u/g was sprayed onto the cores using the following conditions:

| | |
|---|---|
| Fluid feed rate | 16 g/min |
| Atomization air pressure | 30 psi |
| Inlet air temperature | 80° C. |
| Outlet air Temperature | 50° C. |
| Inlet air rate | 80 cfm |

932 g of the coated particles were then coated with 800 g of an aqueous solution containing 40 g of titanium dioxide, 32 g of sucrose and 8 g of NEODOL. The solution was sprayed using the following conditions:

| | |
|---|---|
| Fluid feed rate | 17 g/min |
| Atomization pressure | 40 psi |
| Inlet air temperature | 100° C. |
| Outlet air Temperature | 50° C. |
| Inlet air rate | 70 cfm |

559 g of protease concentrate from Bacilus subtilis coated with a reaction barrier was added to a Glatt Air Uniglatt fluid bed coater and fluidizer. 20.89 g Micrococcus luteus catalase with 20.9% total dry solids and an activity of 3,865,290 IU/ml and applied using the following conditions:

| | |
|---|---|
| Fluid feed rate | 19 g/min |
| Atomization pressure | 40 psi |
| Inlet air temperature | 34° C. |
| Outlet air Temperature | 22° C. |
| Inlet air rate | 45 cfm |

The coated particles were then coated with 480 g of an aqueous solution containing 24 g of titanium dioxide, 19.2 g of sucrose and 4.8 g of NEODOL and applied using the following conditions:

| | |
|---|---|
| Fluid feed rate | 5 g/min |
| Atomization pressure | 40 psi |
| Inlet air temperature | 35° C. |
| Outlet air Temperature | 24° C. |
| Inlet air rate | 45 cfm |

### Example 12

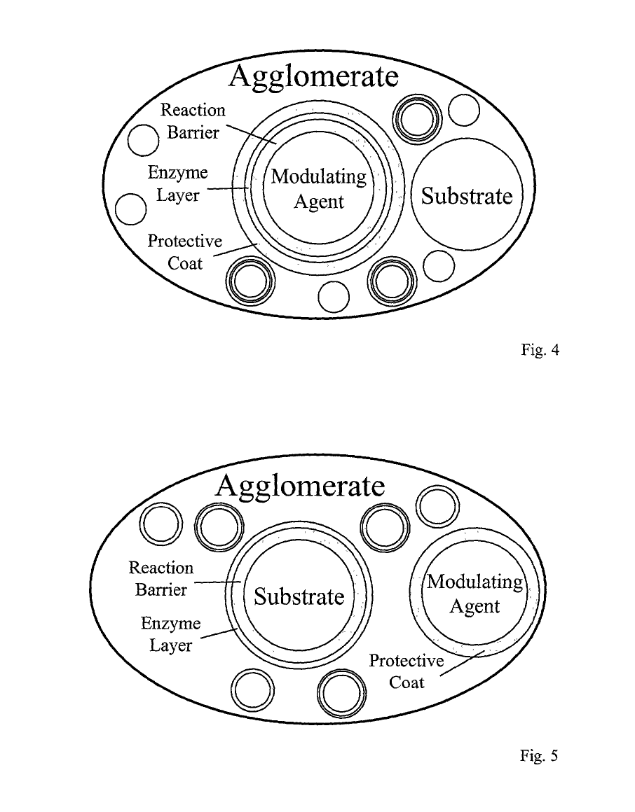

Agglomerates of co-granules comprising (i) granules having a modulating agent, a first reaction barrier layer, a second enzyme layer, and a third protective layer and (ii) substrate granules with enzyme substrate as shown in FIG. 4 were prepared as follows:

132.3 g of sodium perborate monohydrate and 147.6 g of granules already coated with catalase (FIG. 11) were added to a Glatt Air Uniglatt fluid bed coater and fluidizer. 240 g of an aqueous solution containing 12 g of titanium dioxide, 9.6 g of sucrose and 2.4 g of NEODOL and applied using the following conditions:

| | | |
|---|---|---|
| Fluid feed rate | 8 | g/min |
| Atomization pressure | 40 | psi |
| Inlet air temperature | 35° | C. |
| Outlet air Temperature | 24° | C. |
| Inlet air rate | 45 | cfm |

### Example 13

Agglomerates containing two particles wherein the first agglomerate particles are granules with an enzyme substrate core, a first reaction barrier layer and a second enzyme layer and wherein the second agglomerate particles are granules containing a modulating agent core and a protective coat as shown in FIG. 5 were prepared as follows:

93 g of sodium perborate monohydrate coated with catalase (FIG. 10) and 93 g of granules before the catalase layer (first part of Example 11 before catalase was added) were added to a Glatt Air Uniglatt fluid bed coater and fluidizer. 160 g of an aqueous solution containing 8 g of titanium dioxide, 6.4 g of sucrose and 1.6 g of NEODOL and applied using the following conditions:

| | | |
|---|---|---|
| Fluid feed rate | 5 | g/min |
| Atomization pressure | 40 | psi |
| Inlet air temperature | 30° | C. |
| Outlet air Temperature | 22° | C. |
| Inlet air rate | 20 | cfm |

### Example 14

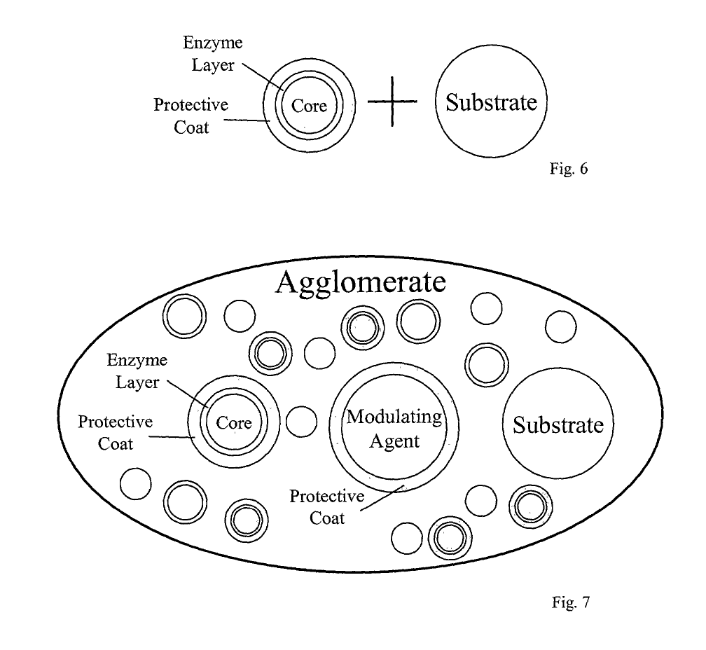

A granule system comprising a substrate granule and an enzyme granule having a core, first enzyme layer and a protective coat is shown in FIG. 6. The enzyme granules were prepared as follows:

186 g of sucrose was added to a Glatt Air Uniglatt fluid bed coater and fluidizer. 6.94 g Micrococcus luteus catalase with 20.9% total dry solids and an activity of 3,865,290 IU/ml and applied using the following conditions:

| | | |
|---|---|---|
| Fluid feed rate | 3 | g/min |
| Atomization pressure | 40 | psi |
| Inlet air temperature | 34° | C. |
| Outlet air Temperature | 26° | C. |
| Inlet air rate | 20 | cfm |

160 g of an aqueous solution containing 8 g of titanium dioxide, 6.4 g of sucrose and 1.6 g of NEODOL was applied using the following conditions:

| | | |
|---|---|---|
| Fluid feed rate | 4 | g/min |
| Atomization pressure | 40 | psi |
| Inlet air temperature | 38° | C. |
| Outlet air Temperature | 28° | C. |
| Inlet air rate | 20 | cfm |

### Example 15

Agglomerates containing three granular particle types as shown in FIG. 7 were prepared as described herein. The first agglomerate granular particles have a modulating agent core and a protective coat. The second agglomerate granular particles have a core, a first enzyme layer and a second protective coat. The third agglomerate granular particles comprise enzyme substrate.

83.7 g of sodium perborate monohydrate, 93 g of granules before the catalase layer (first part of Example 11 before catalase was added) and 93 g of catalase granules (Example 14) were added to a Glatt Air Uniglatt fluid bed coater and fluidizer. 232 g of an aqueous solution containing 11.6 g of titanium dioxide, 9.3 g of sucrose and 2.32 g of NEODOL and applied using the following conditions:

| | | |
|---|---|---|
| Fluid feed rate | 5 | g/min |
| Atomization pressure | 40 | psi |
| Inlet air temperature | 30° | C. |
| Outlet air Temperature | 22° | C. |
| Inlet air rate | 20 | cfm |

### Example 16

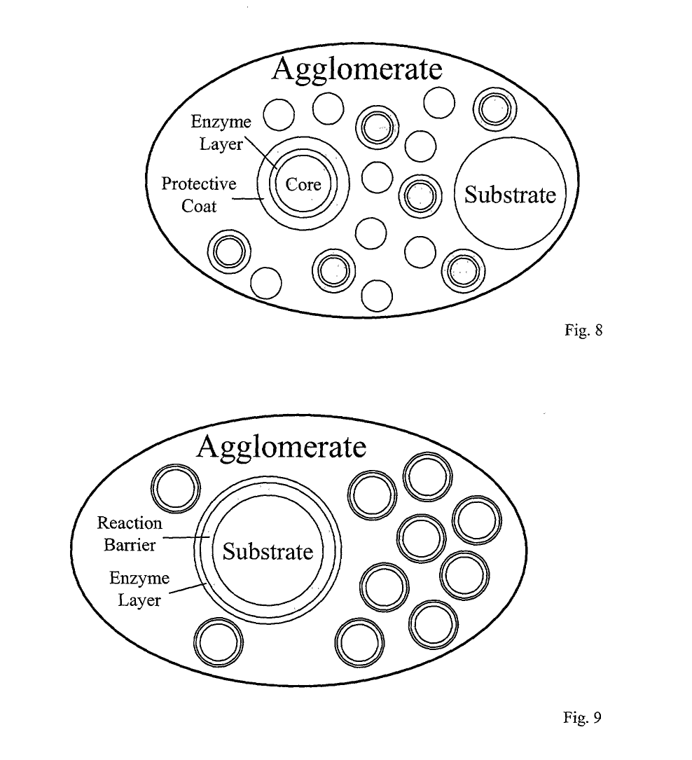

Agglomerates containing two particle types as shown in FIG. 8 were prepared as described herein. The first agglomerate granular particles have a core, a first enzyme layer and second a protective coat. The second agglomerate granular particles comprise enzyme substrate.

82.5 g of sodium perborate monohydrate, 82.5 g of catalase granules (Example 14) were added to a Glatt Air Uniglatt fluid bed coater and fluidizer. 160 g of an aqueous solution containing 8 g of titanium dioxide, 6.4 g of sucrose and 1.6 g of NEODOL and applied using the following conditions:

| | | |
|---|---|---|
| Fluid feed rate | 5 | g/min |
| Atomization pressure | 40 | psi |
| Inlet air temperature | 34° | C. |
| Outlet air Temperature | 25° | C. |
| Inlet air rate | 20 | cfm |

### Example 17

Agglomerates of granular particles having an enzyme substrate core, a first reaction barrier layer and a second enzyme layer as shown in FIG. 9 were prepared as follows:

180 g of sodium perborate monohydrate was added to a Glatt Air Uniglatt fluid bed coater and fluidizer. 235.29 g of an aqueous solution containing 11.76 g of titanium dioxide, 9.41 g of sucrose and 2.35 g of NEODOL and applied using the following conditions:

| | | |
|---|---|---|
| Fluid feed rate | 10 | g/min |
| Atomization pressure | 40 | psi |
| Inlet air temperature | 35° | C. |
| Outlet air Temperature | 24° | C. |
| Inlet air rate | 45 | cfm |

The coated particles were then coated with 6.94 g Micrococcus luteus catalase with 20.9% total dry solids and an activity of 3,865,290 IU/ml and applied using the following conditions:

| | | |
|---|---|---|
| Fluid feed rate | 19 | g/min |
| Atomization pressure | 40 | psi |
| Inlet air temperature | 34° | C. |
| Outlet air Temperature | 22° | C. |
| Inlet air rate | 45 | cfm |

80 g of an aqueous solution containing 4 g of titanium dioxide, 3.2 g of sucrose and 0.8 g of NEODOL and applied using the following conditions:

| | | |
|---|---|---|
| Fluid feed rate | 10 | g/min |
| Atomization pressure | 30 | psi |
| Inlet air temperature | 24° | C. |
| Outlet air Temperature | 22° | C. |
| Inlet air rate | 20 | cfm |

### Example 18

Samples of compositions made in accordance with the procedures described in Examples 10 to 17 were tested for their gas producing properties in accordance with the fizzing assay. The results are set forth in Table 11. Note that the number of samples tested per example varied. Thus 8 samples from Example 10 were tested, 4 samples from Example 14 were tested, and only 1 sample from each of the other Examples was tested. The results show that all the compositions, except those from Examples 12, 15, and 16, achieved the desired score of 35.

As is apparent, the first 4 samples of Example 10 tested achieved scores of 40. Generally, samples that are capable of achieving a grade of 40 or higher within the described time period are preferred. Moreover, those that can achieve the desired gas producing effect at low granule doses in detergent are particularly preferred and those that can achieve the same effect with low enzyme doses are even more preferred.

For example, the third sample has a score 40 and contains only 1.59% in the detergent scoop and has a TCA protein dose of 5.2 mg/g of granule. This composition is certainly more desirable than the penultimate sample which has a score of 20 and which is present at a higher concentration (9.56%) in the detergent dose. In addition, the third sample is also more desirable than the second sample which also has score of 40, is present at the same concentration (1.59%), but which has a higher protein dose of 12.88 mg/g of granule.

TABLE 11

| | | mg Protein/ | | | | | | |
|---|---|---|---|---|---|---|---|---|
| | | g granule | | | | | | |
| | | (Total | | | | | | |
| | | Protein/granule) | | | | | | |
| | | TCA/BCA method | | | | | | |
| Granule | | where protein is 50% | | | | Perborate | | % Granule in |
| (Example) | g | Catalase | Core | Reaction Barrier | Protective Coat | g | Grade | Scoop of Product |
| 10 | 1.25 | 9.07^{a} | Perborate | 10% | 6.8% | 1.0375^{b} | 40 | 1.99% |
| | | | | Suc/TiO2/Neodol | Suc/TiO2/Neodol | | | |
| 10 | 1 | 12.88^{c} | Perborate | 10% | — | 0.9^{b} | 40 | 1.59% |
| | | | | Suc/TiO2/Neodol | | | | |
| 10 | 1 | 5.2^{a} | Perborate | 10% | — | 0.9^{b} | 40 | 1.59% |
| | | | | Suc/TiO2/Neodol | | | | |
| 10 | 1.25 | 2.14^{a} | Perborate | 10% | — | 1.125^{b} | 40 | 1.99% |
| | | | | Suc/TiO2/Neodol | | | | |
| 10 | 1.25 | 1.01^{a} | Perborate | 10% | — | 1.125^{b} | 35 | 1.99% |
| | | | | Suc/TiO2/Neodol | | | | |
| 10 | 4 | 0.91^{c} | Perborate | 20% | — | 3.2^{b} | 35 | 6.37% |
| | | | | Suc/TiO2/Neodol | | | | |
| 10 | 5 | 0.76^{c} | Perborate | 35% | — | 3.25^{b} | 35 | 7.97% |
| | | | | Suc/TiO2/Neodol | | | | |
| 10 | 1.25 | 0.57^{c} | Perborate | 10% | — | 1.0375^{b} | 35 | 1.99% |
| | | | | Suc/TiO2/Neodol | | | | |
| 11 | 4 | 0.89^{c} | Protease | 10% | 6.8% | 1.25^{d} | 35 | 8.37% |
| | | | conc. From | Suc/TiO2/Neodol | Suc/TiO2/Neodol | | | |
| | | | Bacillusin | | | | | |
| | | | subtilis | | | | | |
| 12 | 6 | 0.44^{c} | Protease | 10% | 6.8% | 3^{b} | 25 | 9.56% |
| | | | conc. From | Suc/TiO2/Neodol | Suc/TiO2/Neodol | | | |
| | | | Bacillusin | | | | | |
| | | | subtilis | | | | | |
| | | | | | | | after 2 sec delay | |
| 13 | 3.5 | 0.47^{c} | Perborate | 10% | — | 1.575^{b} | 35 | 5.58% |
| | | | | Suc/TiO2/Neodol | | | | |
| 14 | 5 | 1.85^{c} | Sucrose | — | 6.8% | 1.25^{d} | 35 | 9.96% |
| | | | | | Sucrose/TiO2/ | | | |
| 14 | 3 | 1.98^{c} | Sucrose | — | — | 1.25^{d} | 35 | 6.77% |
| 14 | 2 | 9.76^{c} | Sucrose | — | 6.8% | 1.25^{d} | 35 | 5.18% |
| | | | | | Suc/TiO2/Neodol | | | |
| 14 | 1.25 | 10.47^{c} | Sucrose | — | — | 1.25^{d} | 35 | 3.98% |
| | | | | | | 2 | | |
| 15 | 6 | 0.34^{c} | Sucrose | — | 6.8% | 2^{b} | 25 | 9.56% |
| | | | | | Suc/TiO2/Neodol | | | |
| 16 | 6 | 0.47^{c} | Sucrose | — | 6.8% | 3^{b} | 20 | 9.56% |
| | | | | | Suc/TiO2/Neodol | | | |
| 17 | 1.25 | 10.99^{c} | Perborate | 10% | 6.8% | 1.0375^{b} | 35 | 1.99% |
| | | | | Suc/TiO2/Neodol | Suc/TiO2/Neodol | | | |

(1-2 s slower)

^{a}mg protein per g granule was determined by dissolving the granule, precipitating protein with TCA, and measuring the protein by the BCA method where catalase accounts for only 50% of the TCA precipitated, BCA determined total protein as measured by densitometry on SDS-PAGE.
^{b}This mass is the perborate component of the granule mass. This mass is not added to the total particle/granule requirement: “% target fizzing effect needed in Final Product.”
^{c}This mg protein per g granule was determined by calculating the amount of TCA/BCA protein sprayed onto the granule, assuming an 80% yield, where catalase accounts for only 50% of the TCA precipitated, BCA determined total protein as measured by densitometry on SDS-PAGE.
^{d}The amount of perborate supplemented to the enyzme-only granule to achieve target fizzing effect. This mass is also included in the total particle/granule requirement.

### Example 19

Samples of compositions made in accordance with the procedures described in Examples 10 to 17 were also tested by comparing the amount of foam generated in accordance with the foam imaging assay. The results are set forth in Table 12. As is apparent, all of the samples generated a significant amount of foam.

The results of this assay are consistent with those of the fizzing assay of Example 18. In a similar vein, samples that can generate the desired amount of foam at low granule and enzyme dosages are preferred. The data from Examples 18 and 19 suggest that co-granule samples that contain both the substrate (perborate) and the enzyme (catalase) perform better, that is, less total co-granule is needed to produce the target gas/foaming effect, than samples where the substrate and enzyme are in separate granules. It is expected that agglomerate structures, that do not have a negative modulating agent, will also present a gas/foaming benefit over separate granules, that is, where enzyme and substrate are in separate granules, however, it is expected that such agglomerate structures will exhibit gas/foam properties that are only comparable to those exhibited by the individual co-granules.

TABLE 12

| | | mg Protein/ | | | | | |
|---|---|---|---|---|---|---|---|
| | | g granule | | | | | |
| | | (Total | | | | | |
| | | Protein/granule) | | | | | |
| | | TCA/BCA method | | | | | |
| Granule | | where protein is 50% | | Reaction | | Perborate | % Surface |
| (Example) | g | Catalase | Core | Barrier | Protective Coat | g | Covered |
| 10 | 0.125 | 9.07^{a} | Perborate | 10% | 6.8% | 0.10375^{b} | 52.53 |
| | | | | Suc/TiO2/Neodol | Suc/TiO2/Neodol | | |
| 10 | 0.125 | 12.88^{c} | Perborate | 10% | — | 0.1125^{b} | 62.13 |
| | | | | Suc/TiO2/Neodol | | | |
| 10 | 0.135 | 5.2^{a} | Perborate | 10% | — | 0.1215^{b} | 60.04 |
| | | | | Suc/TiO2/Neodol | | | |
| 10 | 0.175 | 2.14^{a} | Perborate | 10% | — | 0.1575^{b} | 52.08 |
| | | | | Suc/TiO2/Neodol | | | |
| 10 | 2.5 | 0.91^{c} | Perborate | 20% | — | 2^{b} | 52.08 |
| | | | | Suc/TiO2/Neodol | | | |
| 10 | 2.5 | 0.76^{c} | Perborate | 35% | — | 1.625^{b} | 46.54 |
| | | | | Suc/TiO2/Neodol | | | |
| 10 | 0.2 | 0.57^{c} | Perborate | 10% | — | 0.18^{b} | 56.12 |
| | | | | Suc/TiO2/Neodol | | | |
| 11 | 0.3 | 0.89^{c} | Protease | 10% | 6.8% | 0.15^{d} | 33.45 |
| | | | conc. From | Suc/TiO2/Neodol | Suc/TiO2/Neodol | | |
| | | | Bacillusin | | | | |
| | | | subtilis | | | | |
| 12 | 1.5 | 0.44^{c} | Protease | 10% | 6.8% | 0.75^{b} | 59.92 |
| | | | conc. From | Suc/TiO2/Neodol | Suc/TiO2/Neodol | | |
| | | | Bacillusin | | | | |
| | | | subtilis | | | | |
| | | | | | | after 2 sec delay | |
| 13 | 1.2 | 0.47^{c} | Perborate | 10% | — | 0.54^{b} | 65.56 |
| | | | | Suc/TiO2/Neodol | | | |
| 14 | 0.2 | 1.85^{c} | Sucrose | — | 6.8% | 0.15^{d} | 44.19 |
| | | | | | Sucrose/TiO2/ | | |
| | | | | | Neodol/PVA | | |
| 14 | 1.2 | 1.98^{c} | Sucrose | — | — | 0.15^{d} | 30.84 |
| 14 | 0.125 | 9.76^{c} | Sucrose | — | 6.8% | 0.15^{d} | 33.25 |
| | | | | | Suc/TiO2/Neodol | | |
| 14 | 0.25 | 10.47^{c} | Sucrose | — | — | 0.15^{d} | 29.34 |
| 15 | 2.25 | 0.34^{c} | Sucrose | — | 6.8% | 0.75^{b} | 62.27 |
| | | | | | Suc/TiO2/Neodol | | |
| 16 | 1.75 | 0.47^{c} | Sucrose | — | 6.8% | 0.875^{b} | 63.51 |
| | | | | | Suc/TiO2/Neodol | | |
| 17 | 0.4 | 10.99^{c} | Perborate | 10% | 6.8% | 0.332^{b} | 62.94 |
| | | | | Suc/TiO2/Neodol | Suc/TiO2/Neodol | | |
| | | | | | | | (1-2 s slower) |

^{a}mg protein per g granule was determined by dissolving the granule, precipitating protein with TCA, and measuring the protein by the BCA method where catalase accounts for only 50% of the TCA precipitated, BCA determined total protein as measured by densitometry on SDS-PAGE.
^{b}This mass is the perborate component of the granule mass. This mass is not added to the total particle/granule requirement: “% target fizzing effect needed in Final Product.”
^{c}This mg protein per g granule was determined by calculating the amount of TCA/BCA protein sprayed onto the granule, assuming an 80% yield, where catalase accounts for only 50% of the TCA precipitated, BCA determined total protein as measured by densitometry on SDS-PAGE.
^{d}The amount of perborate supplemented to the enyzme-only granule to achieve target fizzing effect. This mass is also included in the total particle/granule requirement.

Although only preferred embodiments of the invention are specifically disclosed and described above, it will be appreciated that many modifications and variations of the present invention are possible in light of the above teachings and within the purview of the appended claims without departing from the spirit and intended scope of the invention.

What is claimed is:

1. A method for enhancing the dissolution of a material in an aqueous solution which method comprises:
(a) selecting a material to be dissolved in an aqueous solution;
(b) incorporating into said material one or more first enzymes and one or more substrates for said one or more first enzymes wherein the combination of said one or more first enzymes and said one or more substrates is capable of producing a gas in the aqueous solution, which gas facilitates dissolution of the material therein; and
(c) optionally, incorporating into said material a modulating agent which modulates the activities of the one or more first enzymes.

2. The method of claim 1 wherein the gas produced is selected oxygen (O₂), carbon dioxide (CO₂), and mixtures thereof.

3. The method of claim 1 wherein the material is selected from the group consisting of laundry detergents, antacids, vitamins, dishwashing detergents, contact lens cleaners, and denture cleaners.

4. The method of claim 1 wherein the material further comprises swelling agents.

5. The method of claim 1 wherein the material further comprises disintegrating agents.

6. The method of claim 1 wherein the one or more first enzymes are selected from the group consisting of catalase, amino acid decarboxylase alcohol dehydrogenase, glucose oxidase/catalase, carbonic anhydrase, amino acid decarboxylase, and mixtures thereof.

7. The method of claim 1 wherein the one or more first enzymes are selected from the group consisting of catalase, amino acid decarboxylase, alcohol dehydrogenase, glucose oxidase, and mixtures thereof.

8. The method of claim 1 wherein the one or more first enzymes are selected from the group consisting of carbonic anhydrase, amino acid decarboxylase, and mixtures thereof.

9. The method of claim 1 wherein the one or more substrates are selected from the group consisting of alcohol, glucose, hydrogen peroxide, bicarbonate, amino acid, sodium perborate, sodium percarbonate, and mixtures thereof.

10. The method of claim 1 wherein the one or more first enzymes is an alcohol dehydrogenase and the one or more substrates is an alcohol.

11. The method of claim 1 wherein the one or more first enzymes is a glucose oxidase and the one or more substrates is glucose.

12. The method of claim 1 wherein the one or more first enzymes is a catalase and the one or more substrates is hydrogen peroxide.

13. The method of claim 1 wherein the one or more first enzymes is a carbonic anhydrase and the one or more substrate is a carbonate.

14. The method of claim 1 wherein the one or more first enzymes is an amino acid decarboxylase and the substrate is an amino acid.

15. The method of claim 1 wherein the modulating agent that is incorporated releases heat that increase the pressure of the gas that is produced.

16. The method of claim 1 wherein the modulating agent that is incorporated is a second enzyme.

17. The method of claim 16 wherein the one or more first enzymes is a hydrogen peroxide catalase and the second enzyme is a protease.

18. The method of claim 1 wherein the aqueous solution contains a bleaching agent and the modulating agent that is incorporated neutralizes the activity of the one or more first enzymes after gas has been produced.

19. The method of claim 1 wherein the material is in the form of a powder, a tablet, a bar, or granule.

20. The method of claim 1 wherein the one or more first enzymes comprise first granules and the one or more substrates comprise second granules.

21. A method for enhancing the dissolution of a material in an aqueous solution which method comprises:
(a) selecting a material to be dissolved in an aqueous solution;
(b) incorporating into said material one or more first enzymes and one or more substrates for said one or more first enzymes wherein the combination of said one or more first enzymes and said one or more substrates is capable of producing a gas in the aqueous solution;
(c) optionally, incorporating into said material modulating agents which modulate the activities of the one or more first enzymes; and
(d) placing said material, produced by steps (b) and (c), into said aqueous solution while maintaining said aqueous solution under conditions wherein a gas is generated by the combination of said one or more first enzymes and said one or more substrates which gas facilitates the dissolution of said material.

22. A detergent composition comprising:
(a) one or more surfactants;
(b) one or more first enzymes;
(c) optionally, modulating agents which modulate the activities of the one or more first enzymes, and
(d) one or more substrates for said one or more first enzymes;
wherein the combination of said one or more first enzymes and said one or more substrates is capable of producing a gas in an aqueous solution.

23. The detergent composition of claim 22 wherein the one or more first enzymes and the one or more substrates are in a homogenous admixture therewith.

24. The detergent composition of claim 23 wherein said composition is in the form of a powder, a tablet, a bar, or granule.

25. The detergent composition of claim 24 wherein the powder, tablet, bar or granule comprises less than 5 weight percent water.

26. The detergent composition of claim 25 wherein the powder, tablet, bar or granule is either individually wrapped or coated with a water resistant barrier.

27. The detergent composition of claim 26 wherein said detergent is a laundry detergent.

28. The detergent composition of claim 26 wherein said detergent is a dishwasher detergent.

29. The detergent composition of claim 22 wherein the modulating agent is capable of releasing heat in the presence of an aqueous medium.

30. The detergent composition of claim 22 wherein the one or more first enzymes comprise first granules and the one or more substrates comprise second granules.

31. A detergent composition comprising one or more surfactants and an enzyme substrate, having admixed thereto one or more granules that comprise:
(a) a first enzyme;
(b) optionally, modulating agents which modulate the activities of the first enzymes; and
(c) a reaction barrier layer that prevents the first enzyme from reacting with the enzyme substrate before the detergent composition is placed in the aqueous solution; and
wherein the combination of the first enzyme and the substrate is capable of producing a gas in an aqueous solution.

32. The detergent composition of claim 31 wherein the modulating agents neutralizes the one or more first enzymes.

33. The detergent composition of claim 32 wherein said modulating agent is selected from the group consisting of proteases, metal or substrate chelators, competing enzymes, denaturants, inhibitors, acid or base additives, and mixtures thereof.

34. The detergent composition of claim 31 wherein said first enzyme is selected from the group consisting of catalase, carbonic anhydrase, glucose oxidase and mixtures thereof.

35. The detergent composition of claim 34 wherein said first enzyme is catalase.

36. The detergent composition of claim 34 wherein said first enzyme is carbonic anhydrase.

37. The detergent composition of claim 31 wherein said substrate is selected from the group consisting of perborate, percarbonate, carbonate, glucose and mixtures thereof.

38. The detergent composition of claim 37 wherein said substrate is perborate or percarbonate.

39. The detergent composition of claim 37 wherein said substrate is carbonate.

40. The detergent composition of claim 31 wherein said surfactant is selected from the group consisting of anionic surfactants, non-ionic surfactants, ampholytic surfactants, and mixtures thereof.

41. A detergent composition comprising one or more surfactants and an enzyme substrate, having admixed thereto one or more granules, wherein said granules comprise:
(a) a surfactant;
(b) a first enzyme; and
(c) optionally, modulating agent which modulate the activities of the first enzymes; and
(d) barrier layer which dissolves in aqueous solution exposing said first enzyme to said enzyme substrate and wherein the combination of the first enzyme and said enzyme substrate is capable of producing a gas in aqueous solution.

42. The detergent composition of claim 41 wherein said enzyme modulators are selected from the group consisting of proteases, metal or substrate chelators, denaturing agents, acid or base additives, and mixtures thereof.

43. The detergent composition of claim 41 wherein said barrier layer dissolves in an aqueous fluid in less than about 60 seconds.

44. The detergent composition of claim 41 wherein said barrier layer is made of material that is selected from the group consisting of polyvinylacetate, methyl cellulose waxes, sodium chloride, sucrose, magnesium sulfate, ammonium sulfate, hydroxypropyl methyl cellulose, ethyl cellulose, carboxymethyl cellulose, acacia gum, polyvinylpyrrolidone, mono- and di-glycerides, polyethylene glycol, non-ionic surfactants, starch, hydroxypropyl starch, hydroxyethyl starch, and mixtures thereof.

45. The detergent composition of claim 41 wherein said first enzyme is selected from the group consisting of catalase, carbonic anhydrase, glucose oxidase and mixtures thereof.

46. The detergent composition of claim 41 wherein said first enzyme is a catalase.

47. The detergent composition of claim 41 wherein said first enzyme is a carbonic anhydrase.

48. The detergent composition of claim 41 wherein said enzyme substrate is selected from the group consisting of perborate or percarbonate, carbonate, glucose and mixtures thereof.

49. The detergent composition of claim 48 wherein said enzyme substrate is perborate or percarbonate.

50. The detergent composition of claim 48 wherein said enzyme substrate is carbonate.

51. The detergent composition of claim 41 wherein said surfactant is selected from the group consisting of anionic surfactants, non-ionic surfactants, ampholytic surfactants, and mixtures thereof.

52. A detergent composition comprising one or more surfactants having admixed thereto one or more granules, wherein said granules comprise
(b) a core comprising an enzyme substrate;
(b) a first barrier layer surrounding said core;
(c) an enzyme layer containing an enzyme that is compatible with the enzyme substrate such that the combination of said enzyme and said enzyme substrate is capable of producing a gas in an aqueous solution; and
(d) optionally, a second barrier layer surrounding said enzyme layer, wherein said second layer comprises a moisture barrier material.

53. A detergent composition comprising one or more surfactants having admixed thereto one or more granules, wherein said granules comprise:
(a) a core;
(b) a first enzyme layer, surrounding said core, which contains an enzyme that is compatible with an enzyme substrate such that the combination of said enzyme and said enzyme substrate is capable of producing a gas in an aqueous solution;
(c) a second barrier layer surrounding said first enzyme layer;
(d) a third enzyme substrate layer comprising an enzyme substrate; and
(e) optionally, a protective coating surrounding said third enzyme substrate layer.

54. An effervescent composition comprising an effervescent system comprising an enzyme and a substrate, wherein said effervescent composition generates a consumer recognizable signal upon contacting an environment from which generation of a consumer recognizable signal is desired.

55. The effervescent composition of claim 54 wherein the substrate and enzyme are present in a single particle.

56. The effervescent composition of claim 54 wherein the consumer recognizable signal is generated from about 0 to about 5 minutes after the effervescent composition is contacted with said environment.

57. The effervescent composition of claim 54 wherein the consumer recognizable signal is generated from about 1 second to about 3 minutes after the effervescent composition is contacted with said environment.

58. The effervescent composition of claim 54 wherein the consumer recognizable signal is generated from about 1 second to about 2 minutes after the effervescent composition is contacted with said environment.

59. The effervescent composition of claim 54 wherein the consumer recognizable signal is generated from about 1 second to about 15 seconds after the effervescent composition is contacted with said environment.

60. The effervescent composition of claim 54 wherein the consumer recognizable signal comprises a bubble.

61. The effervescent composition of claim 54 wherein the consumer recognizable signal comprises foam.

62. The effervescent composition of claim 54 wherein the consumer recognizable signal comprises a change in color.

63. The effervescent composition of claim 54 wherein the consumer recognizable signal comprises a color change.

64. The effervescent composition of claim 54 wherein the effervescent composition comprises an inner core comprising the enzyme and an outer layer comprising the substrate.

65. The effervescent composition of claim 64 wherein the effervescent composition further comprises an intermediate layer positioned between the inner core and the outer layer, wherein the intermediate layer comprises a barrier material.

66. The effervescent composition of claim 54 wherein the effervescent composition comprises an inner core comprising the substrate and an outer layer comprising the enzyme.

67. The effervescent composition of claim 65 wherein the effervescent composition further comprises an intermediate layer positioned between the inner core and the outer layer, wherein the intermediate layer comprises a barrier material.

68. The effervescent composition of claim 54 wherein the gas comprises oxygen and/or carbon dioxide.

69. The effervescent composition of claim 54 wherein the effervescent composition is selected from the group consisting of laundry detergents, dishwashing detergents, hard surface cleaners, toilet bowl cleaners, and mixtures thereof.

70. The effervescent composition of claim 54 wherein the enzyme comprises catalase and/or amino acid decarboxylase, alcohol dehydrogenase, and/or glucose oxidase and/or carbonic anhydrase.

71. The effervescent composition of claim 54 wherein the substrate comprises hydrogen peroxide and/or bicarbonate and/or glucose and/or alcohol and/or amino acid and/or sodium perborate and/or sodium percarbonate.

72. The effervescent composition of claim 54 wherein said composition further comprises a surfactant.

73. The effervescent composition of claim 54 wherein said composition further comprises a coloring agent and/or dye.

74. A detergent composition comprising:
a. an effervescent composition according to claim 54; and
b. a surfactant.

75. A method of making the effervescent composition of claim 54 said method comprising the steps of identifying an enzyme and substrate combination adapted for consumer-recognizable signal generation and incorporating said enzyme and substrate combination into a form suitable for generation of a consumer-recognizable signal.

76. The method of claim 75 wherein said form is such that interaction between said effervescent particle and the liquid is prevented until generation of a consumer recognizable signal is desired.

77. The method of claim 75 wherein said form is selected from the group consisting of: granules, particles, tablets and mixtures thereof.

78. A method of producing an effervescent system and/or composition comprising the steps of identifying an enzyme and substrate combination adapted for generation of a consumer-recognizable signal.

79. The method of claim 78 wherein said effervescent system and/or composition is a consumer product is selected from the group consisting of a fabric care and/or cleaning product, an oral hygiene product, a home care product, a beauty care product, a heath care product and combinations thereof.

80. The method of claim 78 wherein said signal comprises a consumer-recognizable change in a physical and/or chemical property of the environment from which generation of a consumer-recognizable signal is desired.

81. A method of generating a consumer recognizable signal comprising the steps of placing an effervescent system and/or composition into an environment from which generation of a consumer-recognizable signal is desired.
